(19) United States
(12) Patent Application Publication
(10) Pub. No.: US 2025/0248785 A1
(43) Pub. Date: Aug. 7, 2025

(54) ARCH FIXATOR

(71) Applicant: Jeremy Lane Thompson, Eagle Mountain, UT (US)

(72) Inventor: Jeremy Lane Thompson, Eagle Mountain, UT (US)

(21) Appl. No.: 18/435,516

(22) Filed: Feb. 7, 2024

(51) Int. Cl. A61C 1/08; A61C 9/00; A61C 19/10

(52) U.S. Cl. CPC A61C 1/084; A61C 9/0053; A61C 19/10

(57) ABSTRACT

An apparatus for providing a stable reference and mounting point within a patient's jaw is disclosed. In one embodiment, such an apparatus includes a dental appliance for affixing within a jaw of a patient. The dental appliance is sized and shaped to substantially reside within an arch created by an alveolar ridge of the jaw. The dental appliance provides a mounting site for one or more of a tracking mechanism of a surgical robot, fiducial markers used to image the jaw, and an arch of prosthetic teeth. The dental appliance may be designed for either the maxilla or mandible of the jaw and may be designed to make at least three points of contact with the jaw to provide stability thereto. In certain embodiments, the dental appliance is affixed to the patient's jaw with at least one screw such as a single palatal screw. A corresponding method is also disclosed.

### BACKGROUND

### Field of the Invention

This invention relates to dentistry, and more particularly to systems and methods for outfitting a patient with prosthetic teeth.

### Background of the Invention

Full-arch dentistry refers to the branch of dentistry that replaces a patient's natural teeth with full arches of prosthetic teeth. This may be performed for the upper and/or lower arches of the patient's teeth. This is typically accomplished by placing implants into the bone of the upper and/or lower arches of the patient's mouth and then attaching full arches of prosthetic teeth to these implants, typically with screws. Shortly after implants are placed in the patient's mouth but prior to attaching permanent prosthetic teeth to the implants, temporary arches of prosthetic teeth may be attached to the implants to allow the patient's gums and bone time to heal from the implant placement surgery, and to see if the patient likes the size, color, feel, and/or performance (e.g., talking, chewing, etc.) of the temporary arches.

Currently, implants may be placed using a surgical guide that attaches to a patient's existing teeth and/or gums to provide a guide for drilling holes for the implants. However, these surgical guides may have some significant limitations. For example, the surgical guides may obscure the dentist's view of the patient's mouth and make it difficult for the dentist to feel the bone into which the holes are being drilled, potentially causing non-optimal or unsatisfactory placement of the implants. The surgical guides also typically need to be made in a laboratory before the dentist can proceed with the implant-placement surgery. This adds significant time, expense, and patient visits to perform the full-arch procedure.

In addition, the temporary arches that are attached to the implants also typically need to be outsourced to a laboratory that is located remotely from the dentist's office. These temporary arches are also expensive and may take significant time to get back from the laboratory. In short, using current techniques, replacing a patient's natural teeth with full arches of prosthetic teeth typically requires a significant amount of pre-planning and outsourcing to a laboratory. This requires significant time, expense, and additional patient visits. If any of the temporary arches or surgical guides are not correct, the laboratory may need to be called upon again to make necessary corrections. Even with the added time and expense, current techniques may also result in a unsatisfactory or non-optimal end product, with the potential for non-optimal or unsatisfactory placement of the implants and temporary arches that are not optimal or satisfactory in terms of size, color, feel, and performance. In view of the foregoing, new systems and methods are needed to optimally outfit patients with prosthetic teeth.

### SUMMARY

The invention has been developed in response to the present state of the art and, in particular, in response to the problems and needs in the art that have not yet been fully solved by currently available apparatus and methods. Accordingly, apparatus and methods for providing a stable reference and mounting point within a patient's jaw are disclosed. The features and advantages of various embodiments of the invention will become more fully apparent from the following description and appended claims, or may be learned by practice of the invention as set forth hereinafter.

Consistent with the foregoing, an apparatus for providing a stable reference and mounting point within a patient's jaw is disclosed. In one embodiment, such an apparatus includes a dental appliance for affixing within a jaw of a patient. The dental appliance is sized and shaped to substantially reside within an arch created by an alveolar ridge of the jaw. The dental appliance provides a mounting site for one or more of a tracking mechanism of a surgical robot, fiducial markers used to image the jaw, and an arch of prosthetic teeth. The dental appliance may be designed for either the maxilla or mandible of the jaw and may be designed to make at least three points of contact with the jaw to provide stability thereto. In certain embodiments, the dental appliance is affixed to the patient's jaw with at least one screw such as a single palatal screw.

A corresponding method is also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a bottom view of one embodiment of an arch fixator in accordance with the invention, in this example an upper arch fixator;

FIG. 2 is a diagram showing various anatomical landmarks of an edentulous maxilla portion of a patient's jaw;

FIG. 3 is a bottom view of the upper arch fixator of FIG. 1 positioned on the edentulous maxilla show in FIG. 2;

FIG. 4 is a bottom view of one embodiment of an upper arch of a full-arch shell temporary coupled to the upper arch fixator of FIG. 1;

FIG. 5 shows various views of the upper arch shown in FIG. 4;

FIG. 6 shows various views of one embodiment of a lower arch of a full-arch shell temporary that may be placed in occlusion with the upper arch;

FIG. 7 shows the lower arch in occlusion with the upper arch;

FIG. 8 is a conceptual view showing a tube that may be coupled to the arch fixator to provide suction within the patient's mouth, as well as piece of foam or similar material that may act as a throat pack;

FIG. 9 is a conceptual view showing a breathing tube that may be incorporated into or used in conjunction with the arch fixator to keep a patient's airway open;

FIG. 10 shows various views of one embodiment of a straight abutment base in accordance with the invention;

FIG. 11 shows various views of one embodiment of an angled abutment base in accordance with the invention;

FIG. 12 shows various views of one embodiment of a ball screw in accordance with the invention;

FIG. 13 shows various views of one embodiment of a snap cap in accordance with the invention;

FIG. 14 shows various views of one embodiment of a “top” for embedding within various types of prosthetic dental devices and for use with the abutment base;

FIG. 15 shows another embodiment of a “top” for embedding within various types of prosthetic dental devices and for use with the abutment base;

FIG. 16 shows various views of one embodiment of a dental implant that may be used in narrow sections of bone;

FIG. 17 shows various views of one embodiment of a ratcheting finger wheel with variable torque adjustment;

FIG. 18 shows various views of one embodiment of a driver in accordance with the invention;

FIG. 19 shows various views of another embodiment of a driver in accordance with the invention;

FIG. 20 shows a more closeup view of the driver head of FIG. 19;

FIG. 21 is a bottom perspective view of another embodiment of an upper arch fixator in accordance with the invention, incorporating a breathing tube;

FIG. 22 shows various views of the arch fixator of FIG. 21;

FIG. 23 shows various views of one embodiment of a lower arch fixator in accordance with the invention;

FIG. 24 shows various views of one embodiment of a bracket or extension that may be used to extend the kinematic mounts of FIGS. 22 and 23; and

FIG. 25 shows various views of another embodiment of a bracket or extension that may be used to extend the kinematic mounts of FIGS. 22 and 23;

FIG. 26 shows various views of one possible modification to the “top” of FIG. 14 that may prevent the top from pivoting once it is locked in place;

FIG. 27 shows various views of another embodiment of a ball screw in accordance with the invention;

FIG. 28 shows various views of another embodiment of a snap cap in accordance with the invention;

FIG. 29 shows various views of one embodiment of an insert for the snap cap of FIG. 28;

FIG. 30 shows various views of another embodiment of an insert for the snap cap of FIG. 28;

FIG. 31 shows various views of one embodiment of a single-pass bur in accordance with the invention;

FIG. 32 shows various views of another embodiment of a breathing tube in accordance with the invention;

FIG. 33 shows various views of another embodiment of a lower arch fixator in accordance with the invention;

FIG. 34 shows various views of one embodiment of a bite block for use with the lower arch fixator of FIG. 33; and

FIG. 35 shows various views of another embodiment of a bite block in accordance with the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As previously described, full-arch dentistry is a branch of dentistry that replaces a patient's natural teeth with full arches of prosthetic teeth. This is typically accomplished by placing implants into the bone of the upper and/or lower arches of the patient's mouth and then attaching arches of prosthetic teeth to these implants, typically with screws. Shortly after implants are placed in the patient's mouth but prior to attaching permanent prosthetic teeth to the implants, temporary arches of prosthetic teeth may be attached to the implants to allow the patient's gums and bone time to heal from the implant placement surgery, and to see if the patient likes the size, color, feel, and/or performance (e.g., talking, chewing, etc.) of the temporary arches.

Conventionally, implants may be placed using a surgical guide that attaches to a patient's existing teeth and/or gums to provide a guide for drilling holes for the implants. However, these surgical guides may have significant limitations. For example, the surgical guides may obscure the dentist's view of the patient's mouth and make it difficult for the dentist to feel the bone into which the holes are being drilled, potentially causing non-optimal or unsatisfactory placement of the implants. In some cases work may need to be repeated if the placement is incorrect or unsatisfactory. The surgical guides also typically need to be made in a laboratory before the dentist can proceed with the implant-placement surgery. This adds significant time, expense, and patient visits to perform the full-arch procedure.

In addition, the temporary arches that are attached to the implants also typically need to be outsourced to a laboratory that is located remotely from the dentist's office. These temporary arches are expensive and may take significant time to get back from the laboratory. In short, using current techniques, replacing a patient's natural teeth with full arches of prosthetic teeth typically requires a significant amount of pre-planning and outsourcing to a laboratory. This requires significant time, expense, and additional patient visits. If any of the temporary arches or surgical guides are not correct, the laboratory may need to be called upon again to make necessary corrections. Even with the added time and expense, current techniques may not result in a satisfactory or optimal end product, with the potential for non-optimal or unsatisfactory placement of the implants and temporary arches that are not optimal or satisfactory in terms of size, color, feel, and performance.

In view of the shortcomings disclosed above, alternative products and techniques are needed for fitting a patient with temporary arches of prosthetic teeth. Ideally, such alternative products and techniques will significantly speed up the process for fitting a patient with temporary prosthetic teeth, significantly reduce costs and the need to pre-plan, and provide the dentist more control over the process as well as the ability to customize and make adjustments to the end product in his or her office without the need for a laboratory. Ideally, such products and techniques will result in more optimally placed implants, as well as temporary prosthetic teeth and eventual permanent prosthetic teeth that are more optimal in terms of size, color, feel, and performance.

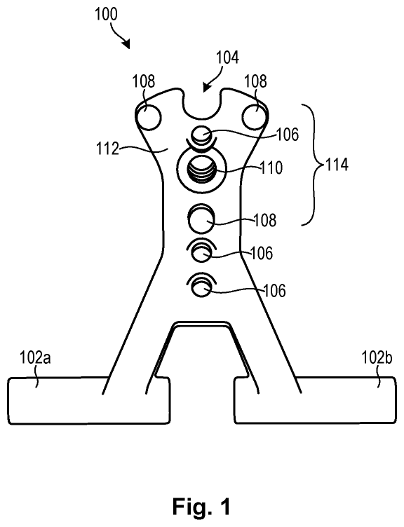

Referring to FIG. 1, recently, dental robots have been developed to assist dentists in performing dental implant surgery. Such robots may enable more accurate and precise placement of the implants. This, in turn, may lead to improved primary stability of the implants. Primary stability is an important factor in successfully placing dental implants. More specifically, it refers to the initial mechanical stability achieved between the dental implant and the surrounding bone at the time of placement. This stability is crucial for the osseointegration process, which is the direct structural and functional connection between living bone and the surface of a load-bearing implant.

In general, robotically placing implants within a patient's mouth may require a planning phase wherein dental imaging is performed. In certain cases, fiducial arrays, also known as fiducial markers or reference markers, may be used to perform this dental imaging. These fiducial arrays may be structures or materials that are rigidly mounted on or near the patient's mouth and placed within a field of view of an X-ray imaging device. The fiducial arrays may serve as reference points or landmarks to enhance the accuracy of diagnosis and treatment planning. Fiducial arrays can be particularly useful with various dental imaging technologies, such as cone-beam computed tomography (CBCT) scans.

In certain embodiments, the same mount that is used to rigidly fix the fiducial array to a patient may be used as a mounting site and reference point for a tracking mechanism (e.g., a tracking arm) of a dental robot. This may enable the dental robot to know where it is relative to the patient at all times and thereby enable the dental robot to accurately place implants or perform other actions (e.g., drill holes, abrade bone, etc.) within the patient's mouth.

In order to ensure that the dental robot is properly calibrated with respect to the patient (e.g., knows where the patient's jaw structures are located relative to the dental robot) any mount that is used for the fiducial array and/or dental robot needs to be rigidly mounted to the patient. Any movement or instability of this mount relative to the patient may throw off the dental robot's calibration and undermine its accuracy and precision relative to the patient. Thus, the design, placement, and rigidity of this mount may be important to achieving a successful outcome in robotic-assisted dental surgery and implant placement.

In certain embodiments in accordance with the invention, a dental appliance 100 (also referred to herein as an “upper arch fixator” 100) may be used to provide, with respect to the upper jaw, a stable mounting site and reference point. More specifically the upper arch fixator 100 may provide a stable mounting site and reference point for a fiducial array as well as a mounting site and reference point for a tracking mechanism of a dental robot used to perform dental surgery such as implant placement. The upper arch fixator 100 may in certain embodiments serve as a kinematic mount for both the fiducial array and the dental robot in that it may constrain all degrees of freedom of the fiducial array and the dental robot with respect thereto.

For example, in the illustrated embodiment, the upper arch fixator 100 includes three posts 108 and an internally threaded aperture 110 to connect the upper arch fixator 100 to external structures such as the fiducial array and dental robot. An area of the upper arch fixator 100 defined by the three posts 108 may form a stable platform 112 or base 112. The three posts 108 may mate with three holes in a mounting surface of the fiducial array and/or dental robot, and a screw associated with the mounting surface may be threaded into the internally threaded aperture 110. This may pull the mounting surface against the base 112 to rigidly attach the fiducial array or dental robot to the upper arch fixator 100. This may constrain all degrees of freedom of the fiducial array and the dental robot with respect to the upper arch fixator 100. The posts 108, platform 112, and internally threaded aperture 110 may collectively form an upper kinematic mount 114 for the upper arch fixator 100.

As shown, in certain embodiments, the upper arch fixator 100 includes a pair of registration members 102a, 102b. These registration members 102a, 102b may be configured to sit in hamular notches of a patient's upper jaw. A centering mechanism 104, such as the illustrated notch 104, may be configured to align with a centrally located anatomical landmark of the patient, such as the patient's incisive papilla. This will center the upper arch fixator 100 relative to the patient's upper jaw and, in combination with the registration members 102a, 102b in the patient's hamular notches, accurately position the upper arch fixator 100 relative to the patient's upper jaw.

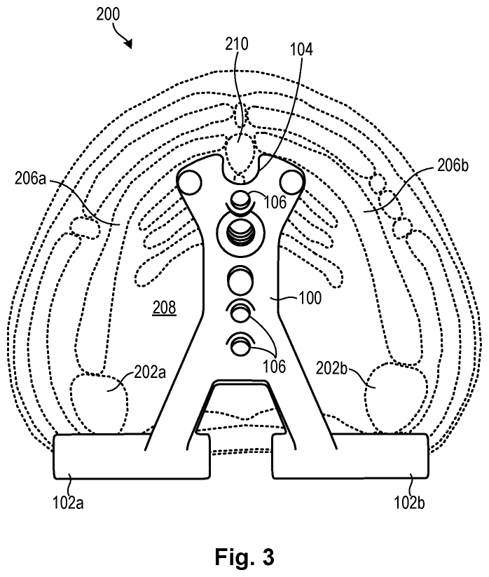

In certain embodiments, the upper arch fixator 100 may be rigidly attached to the patient's upper jaw (and more specifically the patient's palate 208 as shown in FIG. 3) using one or more palatal screws or other fasteners positioned through one or more apertures 106 of the upper arch fixator 100. The screw or screws, in combination with the centering mechanism 104 and the registration members 102a, 102b, may keep the upper arch fixator 100 firmly attached to the patient's upper jaw. Furthermore, at least three points of contact (i.e., the registration members 102a, 102b and the centering mechanism 104) may provide a broad and stable platform and connection to the patient's upper jaw, with all degrees of freedom constrained.

In certain embodiments, the upper arch fixator 100 is fabricated from a rigid material such as polyaramide (i.e., a synthetic polymer) mixed with some percentage of chopped glass (e.g., 40 to 50 percent). This may provide exceptional strength and rigidity to the upper arch fixator 100 while also allowing it to be light weight.

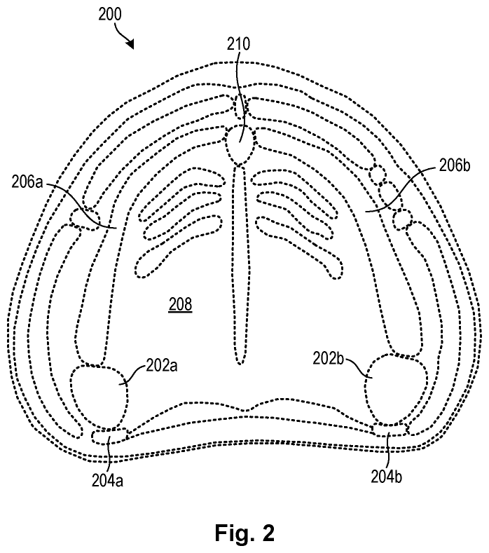

FIG. 2 is a diagram showing various anatomical landmarks of an edentulous maxilla (i.e., upper) portion 200 of a patient's jaw. As shown, the upper jaw 200 may be characterized by an alveolar ridge 206a, 206b which is a bony ridge or raised area in the upper and lower jaws (maxilla and mandible) that contains sockets (alveoli) for the teeth. It is a significant anatomical structure in the oral cavity and plays a central role in supporting and anchoring the teeth. The maxillary tuberosity 202a, 202b sits behind the alveolar ridge 206a, 206b and is a rounded, elevated region in the posterior part of the upper jaw 200. The hamular notches 204a, 204b reside behind the maxillary tuberosity 202a, 202b. The incisive papilla 210 is located at the midline of the hard palate 208 and may serve as a reference point for locating a midline of the upper jaw 200.

FIG. 3 is a bottom view of the upper arch fixator 100 of FIG. 1 positioned on the edentulous maxilla 200 show in FIG. 2. As shown, the registration members 102a, 102b are positioned in the hamular notches of the upper jaw 200. The centering mechanism 104 is aligned with the incisive papilla 210. To maintain this position and firmly mount the upper arch fixator 100 to the patient's upper jaw 200, one or more screws may be installed through one or more of the apertures 106 into the patient's palate 208. In most cases, a single screw may be sufficient to firmly attach the upper arch fixator 100. As shown, once properly installed, the upper arch fixator 100 may be configured to substantially reside within the arch created by the alveolar ridge 206a, 206b of the upper jaw 200. The benefits of this will be described in more detail hereafter.

Because patients may have different size jaws, in certain embodiments, the upper arch fixator 100 may be provided in different sizes, such as small, medium, and large, to accommodate these jaw sizes and also ensure that the upper arch fixator 100 is able to reside within the arch created by the alveolar ridge 206a, 206b of the patient. For example, if a measurement between a line drawn between the hamular notches and the incisive papilla 210 is less than 42 millimeters, a small-sized upper arch fixator 100 may be used; if the measurement is between 42 and 49 millimeters, a medium-sized upper arch fixator 100 may be used; and if the measurement is greater than 50 millimeters, a large-sized upper arch fixator 100 may be used. In certain embodiments, these measurements may be taken from imaging generated from a cone-beam computed tomography scan.

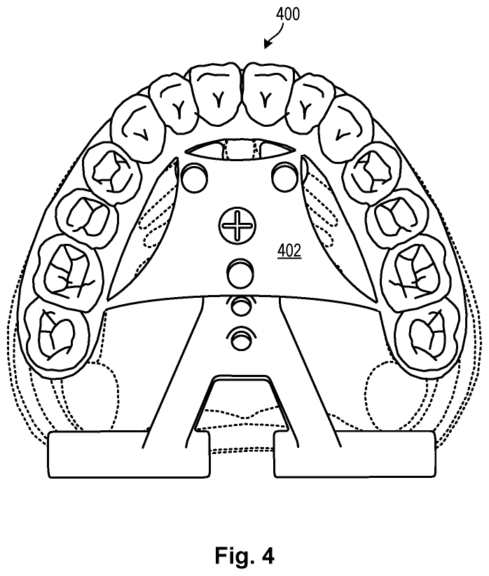

Referring to FIG. 4, in certain embodiments in accordance with the invention, the upper arch fixator 100 previously discussed may also serve as a mounting site and reference point for temporary prosthetic teeth (hereinafter referred to as a “full-arch shell temporary”), and more specifically an upper arch 400 of a full-arch shell temporary. Because the upper arch fixator 100 is precisely positioned relative to a patient's upper jaw 200, the upper arch fixator 100 may be used to precisely position the upper arch 400 of the full-arch shell temporary with respect to the patient's upper jaw 200. Furthermore, because the upper arch fixator 100 substantially resides within the arch created by the alveolar ridge 206a, 206b of the upper jaw 200, the upper arch fixator 100 will ideally not interfere with placement and positioning of the upper arch 400 in the patient's upper jaw 200.

In certain embodiments, the upper arch 400 is equipped with a mounting bracket 402 to attach the upper arch 400 to the upper arch fixator 100 in an anatomically correct position with respect to the patient's upper jaw 200. As shown, the mounting bracket 402 may in certain embodiments include holes or apertures that align with the posts 108 of the upper arch fixator 100. A screw may attach the upper arch 400 to the upper arch fixator 100 when tightened into the internally threaded aperture 110. Once the upper arch 400 is properly fitted to the patient (e.g., filled with reline material so the upper arch 400 conforms to the patient's upper jaw, prepared for connecting to implants in the patient's jaw, etc.) the upper arch 400 may be removed from the upper arch fixator 100 and the mounting bracket 402 may be removed (e.g., ground off, snapped off, etc.). The upper arch 400 may then be re-installed/connected to the patient by way of the implants. This may occur either before or after the upper arch fixator 100 is removed from the patient. In this way, the upper arch fixator 100 may also be used to precisely and accurately place a full-arch shell temporary in a patient's mouth in addition to providing a mounting site and reference point for a fiducial array and dental robot.

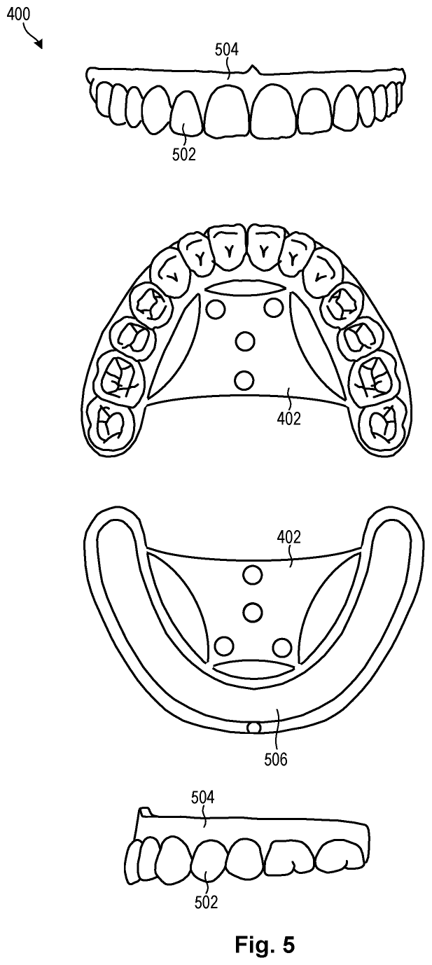

FIG. 5 shows various views of one contemplated embodiment of the upper arch 400 of the full-arch shell temporary, and more particularly, a front view, bottom view, top view, and side view, including the mounting bracket 402. The mounting bracket 402 may take various forms and is not limited to the illustrated configuration. As shown, the upper arch 400 may include a first portion 502 that is made to resemble and function as a person's teeth and a second portion 504 that is made to resemble and function as a person's gums. As further shown in FIG. 5, in certain embodiments, a top side 506 of the upper arch 400 may be hollowed out to enable the upper arch 400 to fit over any protruding bone/gums, implant abutments, and the like when placing the upper arch 400 in a patient's mouth. The full-arch shell temporary may be made of acrylic resin or other materials known in the art of full-arch dentistry. In certain embodiments, the full-arch shell temporary is 3-D printed although the full-arch shell temporary is not limited to any particular method of manufacture.

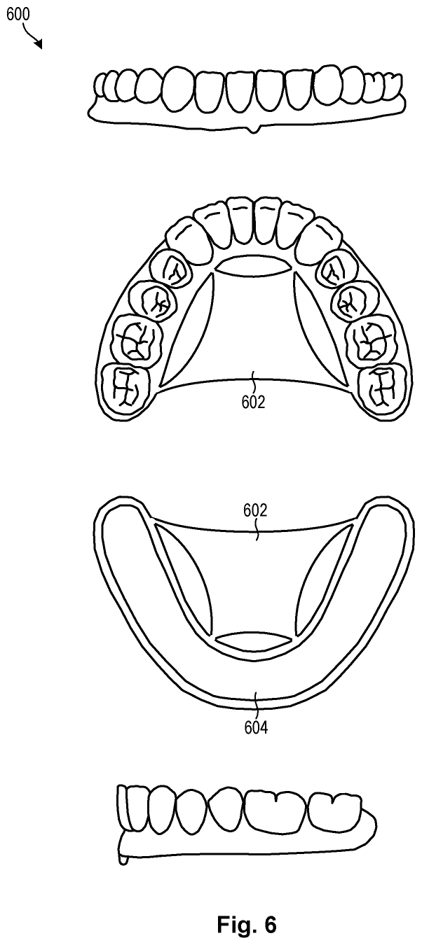

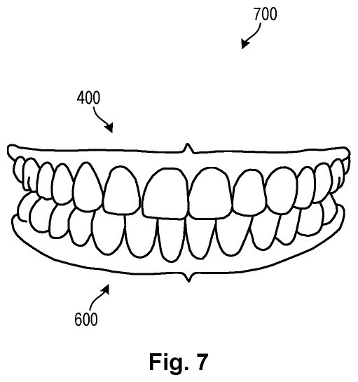

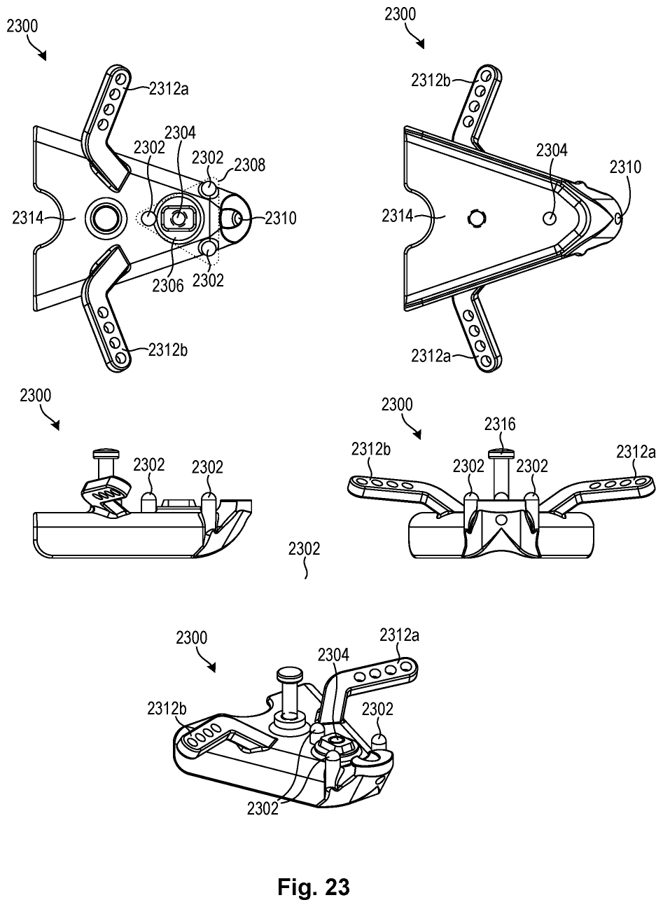

FIG. 6 shows various views of one contemplated embodiment of a lower arch 600 of a full-arch shell temporary 700. Like the upper arch 400, a bottom side 604 of the lower arch 600 may be hollowed out to enable the lower arch 600 to fit over any protruding bone/gums, implant abutments, and the like when placing the lower arch 600 in a patient's mouth. As shown, in certain embodiments, the lower arch 600 may also be equipped with a mounting bracket 602. For example, in certain embodiments, after the upper arch 400 has been attached to the upper arch fixator 100 in the patient's mouth, the lower arch 600 may be brought into occlusion with the upper arch 400, as shown in FIG. 7. The patient's chin may then be raised until an anatomically correct position is achieved between the lower arch 600 and the patient's lower jaw. The mounting bracket 602 may then be glued or otherwise attached to a lower arch fixator that is attached to the patient's lower jaw. This will enable it to maintain its anatomically correct position with respect to the patient's lower jaw, while also ensuring that proper occlusion will be achieved when the upper arch 400 and lower arch 600 are brought together by closing the patient's jaws. One example of a lower arch fixator will be described in association with FIG. 23.

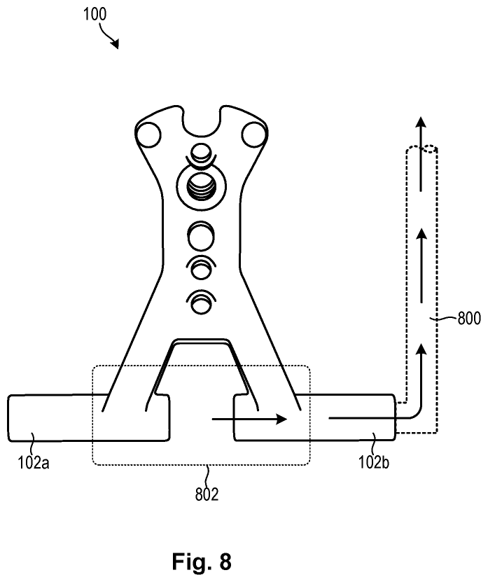

Referring to FIG. 8, in certain embodiments, certain features may be incorporated into the upper arch fixator 100. For example, in certain embodiments, the registration members 102a, 102b are configured as hollow cylinders capable of conveying fluids and/or debris. A tube 800, such as an angled tube 800, may be coupled to one or more of the registration members 102a, 102b to provide suction in the patient's mouth while a dentist is working therein. This may prevent excessive saliva, fluids, and or debris from accumulating in the oral cavity while the dentist is working, prevent the patient from swallowing such materials, and/or provide a clear field of view for a dentist. In certain embodiments, a small piece of foam 802 or other absorbent material 802 (represented by the dotted line 802) may be situated between the registration members 102a, 102b and possibly surround the upper arch fixator 100 in the area around the registration members 102a, 102b to collect saliva or other moisture in the patient's mouth, as well as serve as a throat pack that still allows the patient to breath. The hollow registration members 102a, 102b and tube 800 may apply suction to this material 802 to keep it mostly dry.

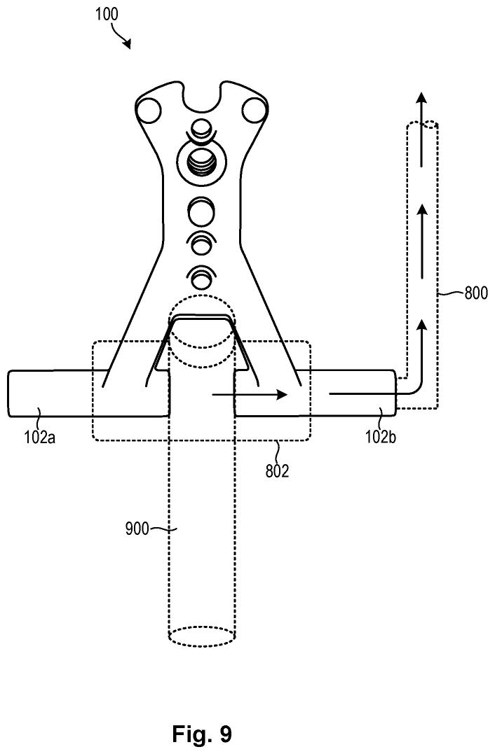

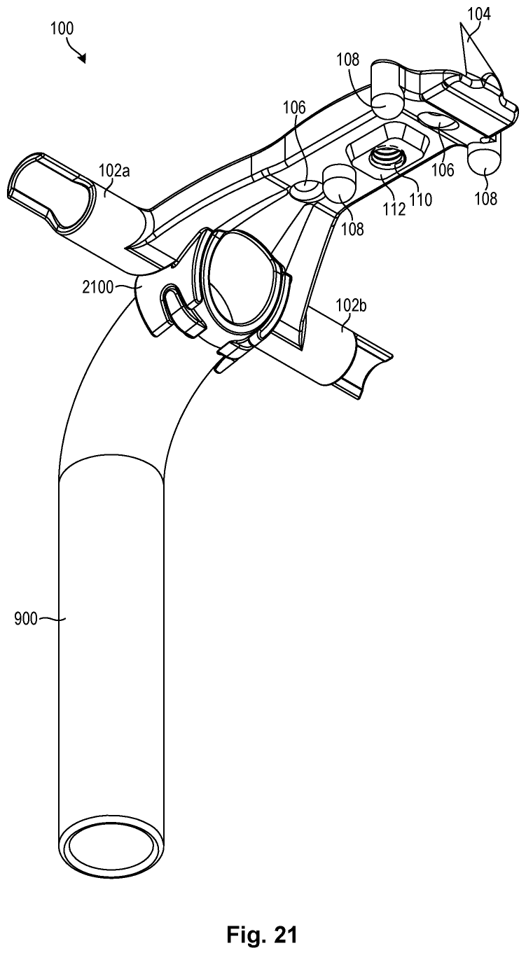

Referring to FIG. 9, in yet other embodiments, a breathing tube 900 may be incorporated into the upper arch fixator 100. This breathing tube 900 may replace the absorbent material 802 and/or be used in conjunction with the absorbent material 802. The breathing tube 900 may extend into a patient's throat (in certain cases just short of the trachea) past the patient's tongue to keep the patient's airway open when the patient is receiving dental work and when the patient may be under anesthesia and need assistance to breathe. One more particular embodiment of an upper arch fixator 100 with a breathing tube 900 will be discussed in association with FIG. 21.

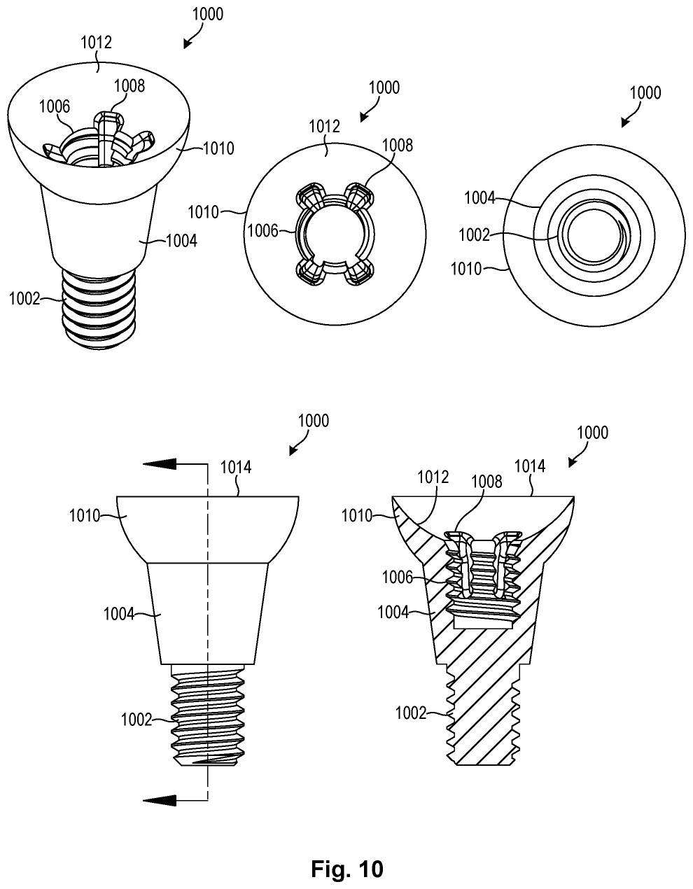

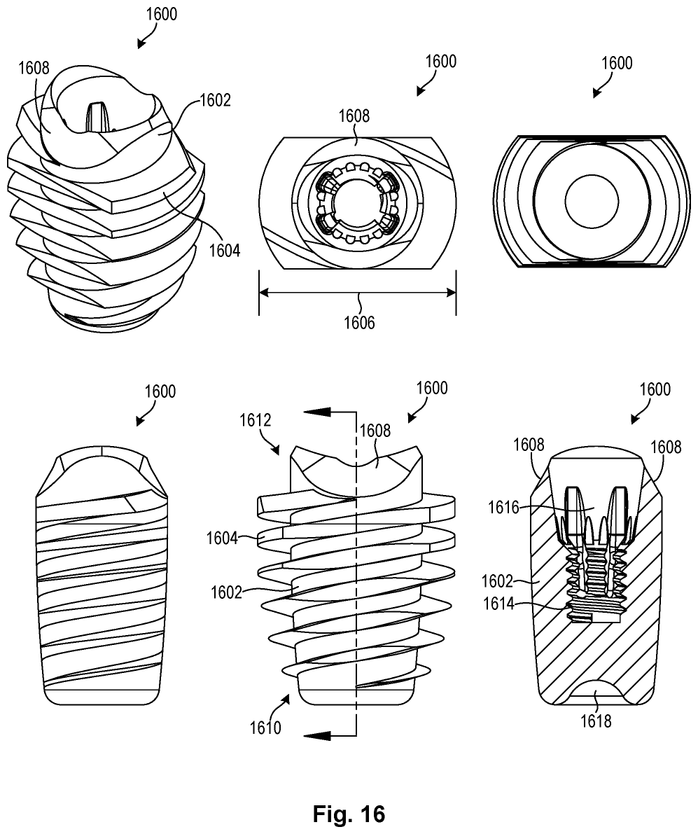

Referring to FIG. 10, once locations are determined for implants in a patient's mouth, holes may be drilled in the patient's jaw bone and implants may be placed in the holes. These implants may provide anchors for the upper arch 400 and the lower arch 600 of the full-arch shell temporary 700. In certain embodiments, four implants may be placed in both the upper and lower jaw to provide anchors for the full-arch shell temporary 300, although other numbers of implants may also be used. One embodiment of an implant will be discussed in association with FIG. 16.

Conventionally, once implants are placed in the jaw of a patient, multi-unit abutments may be used to correct for height variations in the implants, and to establish a level platform for the full-arch shell temporary 700 as well as eventual permanent prosthetic teeth. The multi-unit abutments may also be used to provide a connection to the implants that is even with or just below the gingival surface. In certain cases, angled multi-unit abutments may be used to correct the angle of implants while also keeping screw channels away from facial surfaces of the full-arch shell temporary 300. Nevertheless, conventional angled multi-unit abutments are typically only available in certain fixed angles, such as 17 and 30 degree angles. Unfortunately, these fixed angles may not be ideal in all cases, such as where other intermediate angles would provide a more optimal result.

In certain embodiments in accordance with the invention, an adjustable-angle multi-unit abutment may be provided to provide a much greater range of angles than may be achieved with a fixed-angle multi-unit abutment. FIG. 10 shows various views of one embodiment of an abutment base 1000 that may be used with such a multi-unit abutment, including a perspective, top, bottom, side, and side cross-sectional views. As shown, in certain embodiments, the abutment base 1000 includes external threads 1002 configured to thread into corresponding internal threads of an implant, and a seat 1004 configured to mate with a correspondingly shaped recess in the implant.

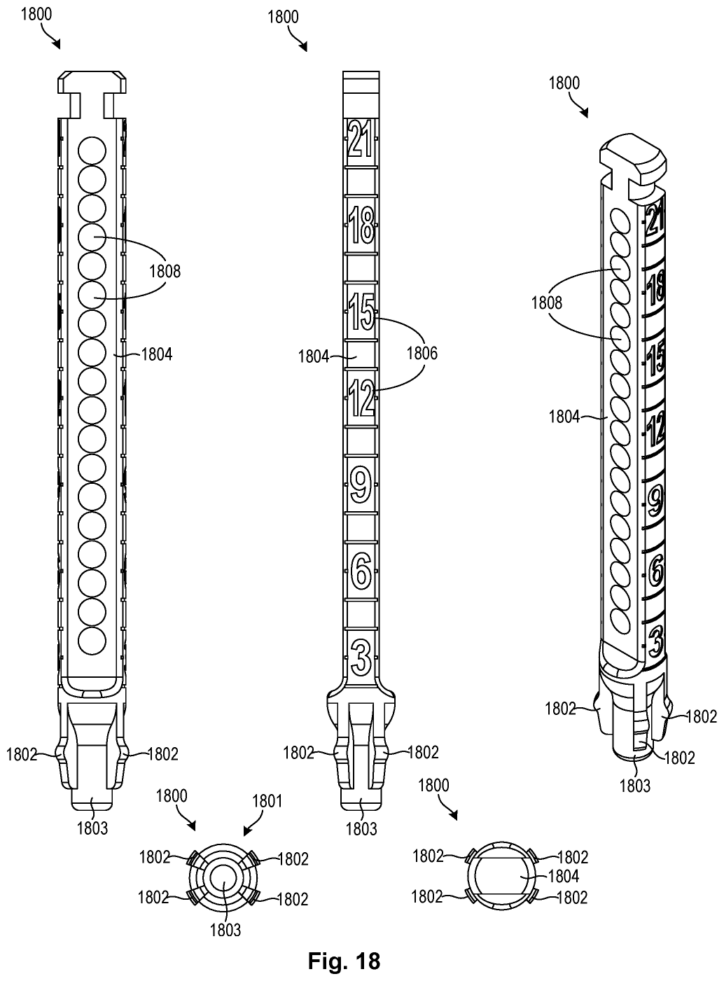

As shown, the abutment base 1000 may also include internal threads 1006 to receive various tops made for various different purposes (e.g., crowns, bridges, full arches, erc.). The abutment base 1000 may also include internal grooves 1008 or recesses 1008 to engage a driver used to turn and tighten the abutment base 1000 into the implant. One embodiment of a driver that may engage with these grooves 1008 or recesses 1008 will be discussed in association with FIG. 18.

As shown in FIG. 10, the abutment base 1000 includes a flared head 1010 along with a rounded concave mating surface 1012 (also referred to herein as a “crucible 1012”). The flared head 1010 may serve to keep a patient's gums or tissue away from the rounded mating surface 1012. The rounded mating surface 1012 may interface with various types of tops having different purposes, several examples of which will be discussed in more detail hereafter. In general, the rounded mating surface 1012 may enable various types of adjustable-angle tops that may rotate with respect to the rounded mating surface 1012 to achieve a desired angle. In certain embodiments, when the abutment base 1000 is installed in an implant and a top edge 1014 of the abutment base 1000 is at or near tissue level, the rounded mating surface 1012 will be below the patient's gum or tissue level, thereby providing a dentist a significant amount of restorative space with which to work to interface with a dental prosthesis.

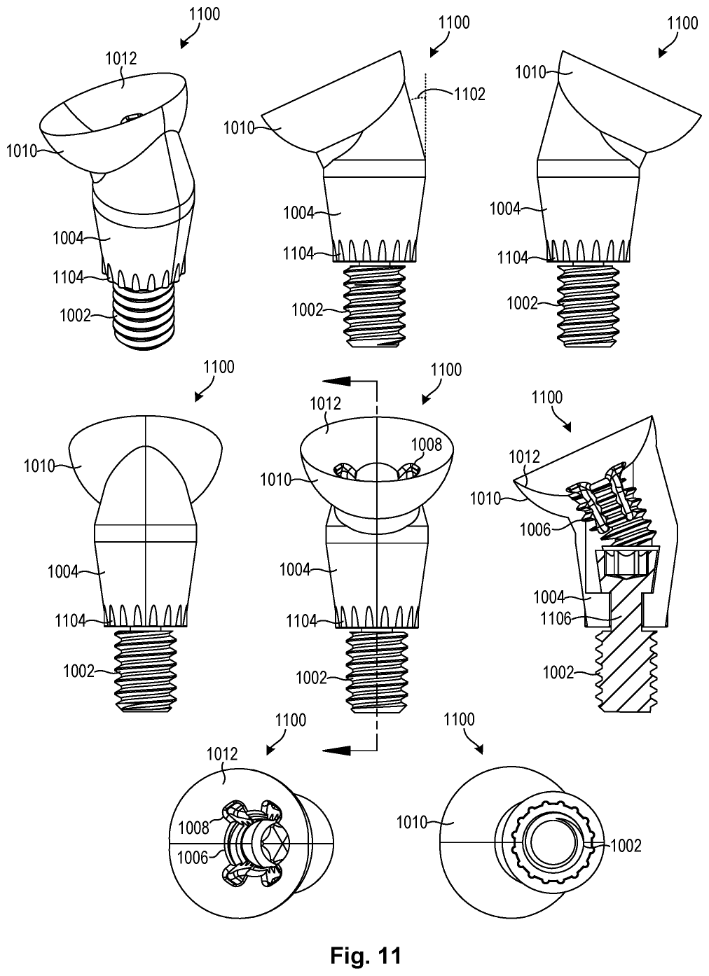

Referring to FIG. 11, in certain embodiments, the abutment base 1000 described in FIG. 10 may be modified to deviate by a desired angle. For various types of tops, this may enable a greater overall angle than what can be achieved using the abutment base 1000 of FIG. 10. For example, if the abutment base 1100 is angled by 25 degrees 1102, as shown in FIG. 11, and the top is able to swivel by 25 degrees with respect to the abutment base 1100, this may enable up to 50 degrees of overall angle correction.

In certain embodiments, in order to prevent rotation of the abutment base 1100 relative to the implant in which it is installed, the abutment base 1100 may include various ridges 1104 or teeth 1104 that interlock with corresponding grooves in the implant, as will be discussed in association with FIG. 16. This may enable the abutment base 1100 to be locked at various positions relative to the implant, depending on the number of teeth 1104 that are on the abutment base 1100. For example, if sixteen teeth 1104 are used, positions may exist at every 22.5 degrees. In certain embodiments, the abutment base 1100 includes a screw 1106 that can be rotated into the implant and thereby lock the ridges 1104 into the corresponding grooves of the implant in whatever position is selected.

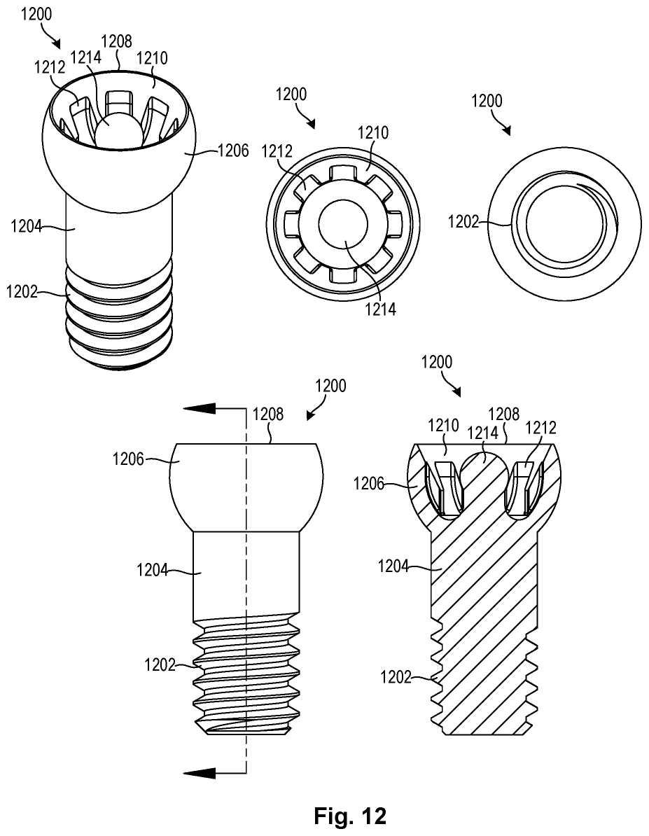

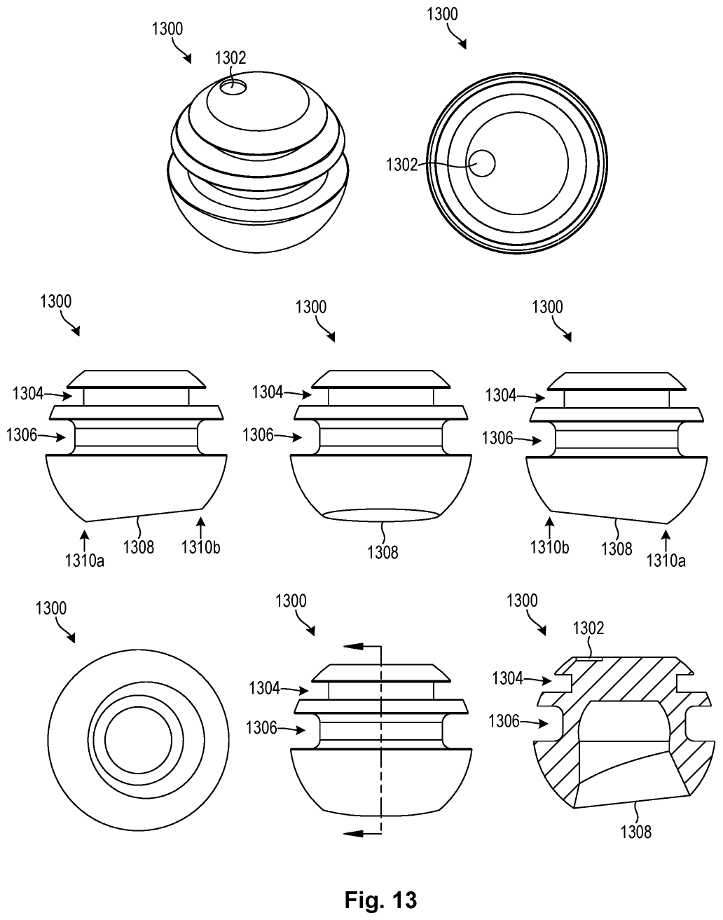

Referring to FIG. 12, as previously mentioned, various types of tops may be used with the abutment bases 1000, 1100 described in association with FIGS. 10 and 11. For example, in one embodiment, a ball shape, such as the illustrated ball screw 1200, may be threaded into either of the abutment bases 1000, 1100. In certain embodiments, the ball screw 1200 may be used with a snap cap, as will be described in association with FIG. 13. FIG. 12 shows various views of the ball screw 1200, including a perspective, top, bottom, side, and side cross-sectional views.

As shown, the ball screw 1200 includes external threads 1202 to thread into an abutment base 1000, a shank 1204 that enables a rounded head 1206 of the ball screw 1200 to reside some distance above the concave mating surface 1012 of the abutment base 1000. The flared head 1010 of the abutment base 1000 may keep tissue away from the shank 1204 and rounded head 1206 of the ball screw 1200. As shown, the rounded head 1206 has an upper rim 1208 with a diameter that is smaller than the overall diameter of the rounded head 1206 at its largest. This may allow a snap cap such as that illustrated in FIG. 13 to snap onto the rounded head 1206 and be retained by gripping the rounded head 1206 until it the snap cap is snapped off.

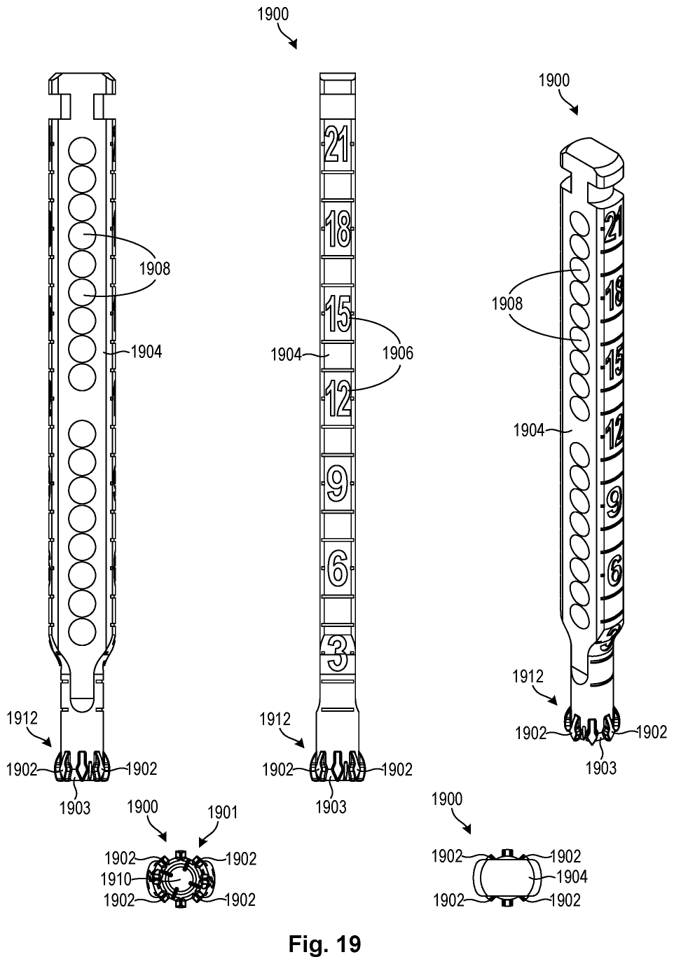

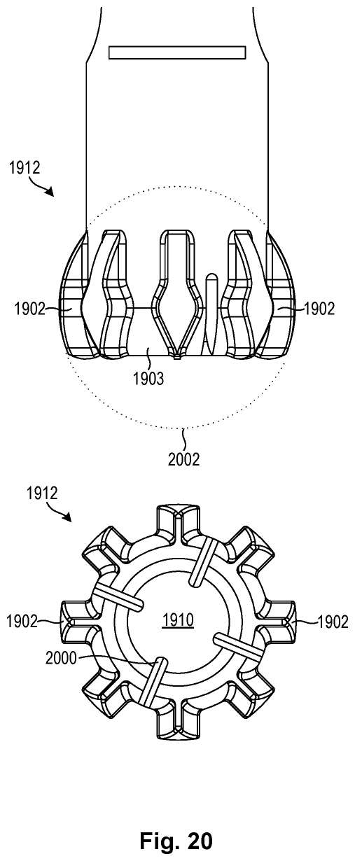

As further shown in FIG. 12, the ball screw 1200 may include a recess for engagement with a driver. In certain embodiments, the recess 1210 is rounded with a series of grooves 1212 configured to engage corresponding teeth of a driver. One embodiment of such a driver will be discussed in association with FIGS. 19 and 20. The unique characteristics of the recess 1210 and associated driver may allow the driver to engage the recess 1210 not only straight on, but also at an angle, such as deviating from straight by as much as 25 degrees. This may be very helpful in tight spaces that are commonly encountered when performing dental work. In certain embodiments, the rounded head 1206 includes a rounded pin 1214 or shaft 1214 that may engage a corresponding recess in the driver, and even allow the driver to snap onto to the pin 1214 or shaft 1214. This may help to keep the driver centered and engaged with the recess 1210.

In certain embodiments, the ball screw 1200 also functions as a scan body. That is, the ball screw 1200 may provide a known geometry that, once installed in a patient's mouth, can be scanned to ascertain its position relative to other dental structures. This may enable implants to be located and a dental prosthesis to be designed and fabricated that will correctly interface with the ball screws 1200 or other components (implants, abutments, tops, etc.)

Referring to FIG. 13, in certain embodiments, it may be desirable to have a full-arch shell temporary 700, and more specifically an upper arch 400 and lower arch 600 of the full-arch shell temporary 700, that can be quickly installed or removed from the patient's mouth. In certain embodiments, it may be desirable to have a full-arch shell temporary 700 that will simply snap into place in the patient's mouth, or quickly unsnap to remove the full-arch shell temporary 700 therefrom.

In order to provide the aforementioned characteristics, in certain embodiments, a snap cap 1300 may be provided. This snap cap 1300 may in certain embodiments be embedded in reline material of a full-arch shell temporary 700 or other dental prosthesis, and may connect to an abutment or other structure attached to an implant, such as the rounded head 1206 of the ball screw 1200 described in FIG. 12. FIG. 13 shows various views of one contemplated embodiment of a snap cap 1300 that may be used to couple a full-arch shell temporary 700 or other dental prosthesis to a ball screw 1200 or other structure.

As shown, in certain embodiments, the snap cap 1300 includes one or more grooves 1304, 1306, a marker 1302, and an angled bottom 1308. For example, once snap caps 1300 are placed over ball screws 1200 that have been installed in implants in a patient's mouth, an orthodontic wire may be placed in a first groove 1304 of the snap caps 1300 to make sure the snap caps 1300 are parallel before they are embedded in reline material of a full-arch shell temporary 700 or other dental prosthesis. A second groove 1306 of the snap caps 1300 may accommodate skirts configured to prevent reline material from coming into contact with the ball screws 1200 or other abutments, thereby preventing the reline material from potentially interfering with the connections between the snap caps 1300 and the ball screws 1200. The grooves 1304, 1306 may also provide surface features to enable the snap caps 1300 to be gripped by the reline material associated with the full-arch shell temporary 700 or other dental prosthesis.

When implants are placed in a patient's mouth, they are almost always tilted toward the patient's cheeks as opposed to toward the patient's tongue due to the shape and flaring out of the jaw. Thus, the snap cap 1300 may in certain embodiments be configured with an angled bottom 1308 to conform to the tilt of the implant. To provide an optimal or improved fit to a patient's jaw, this angled bottom 1308 may be oriented such that a thicker side 1310a of the snap cap 1300 is oriented toward a patient's cheeks/lips, and the thinner side 1310b is oriented toward a patient's tongue. The marker 1302 may be used to determine the orientation of the snap cap 1300 when looking from a top of the snap cap 1300 to ensure that the snap cap 1300 is oriented correctly.

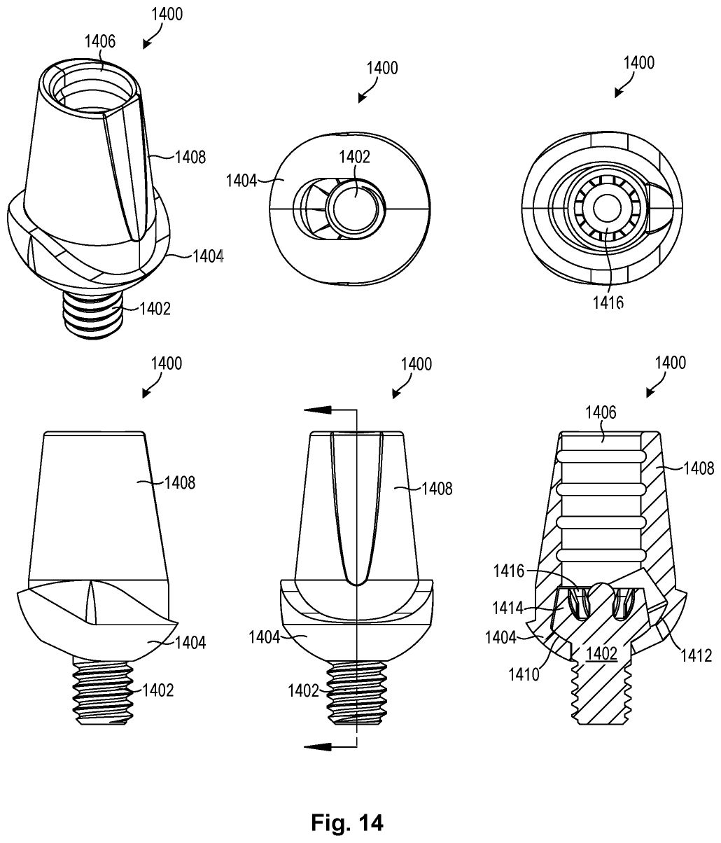

FIG. 14 shows various views of another type of “top” that may be coupled to and pivot relative to the abutment bases 1000, 1100. In this example, the “top” is a cylinder that can be embedded within a crown, bridge, or other dental prosthesis. The angle of the top 1400 is configured to be adjustable. In certain embodiments, the angle is adjustable as much as twenty five degrees relative to a straight orientation.

For example, in certain embodiments, the top 1400 includes an internal screw 1402 to rotate into the internal threads 1006 of the abutment bases 1000, 1100. In certain embodiments, this internal screw 1402 is accessible through a channel 1406 formed in the cylinder portion 1408. This may enable a rounded base 1404 of the top 1400 to seat in the rounded mating surface 1012 of the abutment bases 1000, 1100. While the internal screw is still loose, the rounded base 1404 may rotate relative to the rounded mating surface 1012 or crucible 1012. As stated above, in certain embodiments, this may enable the cylinder portion 1408 to deviate by an angle of up to twenty-five degrees from a straight position. Greater angles may be possible with some redesign of the top 1400.

This angular adjustment may, in certain embodiments, occur along a single plane of the top 1400 and may be facilitated by a rounded bottom 1410 of the internal screw 1402 and enabling this rounded bottom 1410 to slide along a rounded internal track 1412 or channel 1412 within the cylinder portion 1408. Once a desired angle is achieved, the internal screw 1402 may be tightened to lock the angle of the cylinder portion 1408 into place. In certain embodiments, different textures or features or potentially even locking compounds may be integrated into the rounded bottom 1410 of the internal screw 1402 and/or into the internal track 1412 or channel 1412 to increase the strength and resilience of the lock when the internal screw 1402 is tightened.

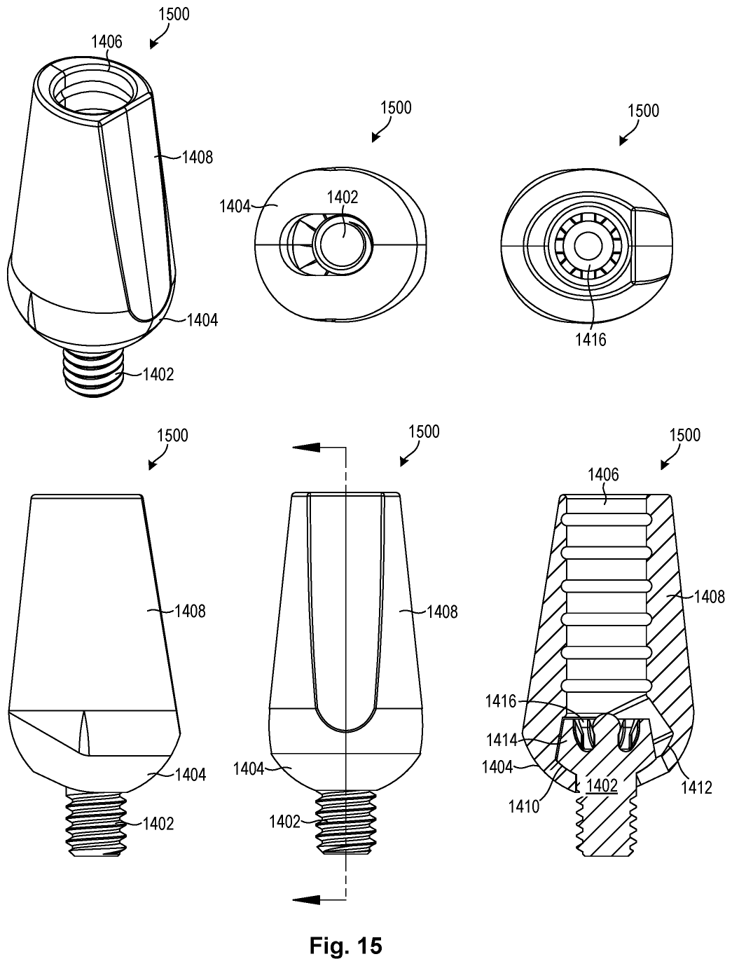

In certain embodiments, the head 1414 of the internal screw 1402 may be configured with a recess 1416 similar to that described in association with the ball screw 1200 shown in FIG. 12. That is, the unique characteristics of the recess 1416 and associated driver may enable the driver to engage the recess 1416 not only straight on, but also at an angle, such as deviating from a straight orientation by as much as 25 degrees. This may enable the internal screw 1402 to be turned and tightened even when the cylinder portion 1408 is angled with respect to the internal screw 1402. FIG. 15 shows one embodiment of a top 1500 that is similar to the top 1400 shown in FIG. 14 except that the top is taller and with thicker walls to accommodate other types of dental prostheses.

In certain embodiments, the tops 1400, 1500 may also function as scan bodies. In certain embodiments, the cylinder portions 1408 are configured with some feature, such as the illustrated flat sides, to enable a scanner to pick up the location and orientation of the tops 1400, 1500. This may enable implants to be located and a dental prosthesis to be designed and fabricated that will interface with the tops 1400, 1500.

Referring to FIG. 16, when a patient loses teeth, the bone around the teeth often shrinks over time and results in bone loss. These are often the very same patients that eventually need or desire dental implants so that a prosthetic dental device (e.g., full-arch prosthetic teeth, bridge, crown, etc.) can be secured within the patient's mouth. This creates a challenge for the dentist to find an area or location with sufficient bone to which to secure a dental implant. It would be an advance in the art to provide a dental implant that provides the stability of a wider implant but may be used in narrower sections of bone caused by bone loss. Various views of one embodiment of such a dental implant 1600 are shown in FIG. 16.

In certain embodiments, a dental implant 1600 in accordance with the invention includes a shaft 1602 and threads 1604 around the shaft 1602. In certain embodiments, the threads 1604 may extend away from the shaft 1602 some designated distance (referred to as “thread depth”) on two opposing sides of the shaft 1602 while being substantially flush with the shaft 1602 on the two opposing sides that are offset by ninety degrees. FIG. 16 shows one embodiment of a dental implant 1600 in accordance with the invention from various different angles.

A dental implant 1600 such as that illustrated in FIG. 16 may enable the dental implant 1600 to be placed in bone such that a long dimension 1606 of the threads runs substantially parallel to the bone. This same dental implant 1600 may be too wide for the bone if the long dimension 1606 were placed perpendicular to the bone. Thus, the illustrated design may enable a larger dental implant 1600 to be placed in the bone than would otherwise be possible with a dental implant with conventional circular threads. Because a patient may have more bone from front to back than from side to side within the patient's mouth, the illustrated dental implant 1600 may have significant utility when placing implants. In certain embodiments, in order to assist a dentist in correctly orienting the dental implant 1600, a marker may be placed on the dental implant 1600, such as on a top of the dental implant 1600, so that the dentist can verify that a long dimension 1606 of the dental implant 1600 is oriented parallel to the bone. For example, the illustrated chamfers 1608 may be used to verify that a long dimension 1606 of the dental implant 1600 is oriented parallel to the bone.

As shown in FIG. 16, in certain embodiments, the threads 1604 of the dental implant 1600 may increase in thickness from a leading end 1610 of the dental implant 1600 to a trailing end 1612 of the dental implant 1600. This may increase the stability of the dental implant 1600 since the threads 1604 may provide greater interference and contact with the bone as they are threaded into the bone. As further shown in FIG. 16, the dental implant 1600 may include internal threads 1614 to receive an abutment such as the abutment bases 1000, 1100 previously described. The dental implant 1600 may further include a recess 1616 or socket 1616 to enable a driver to engage the dental implant 1600 and turn the dental implant 1600 and thereby install the dental implant 1600 into bone. One embodiment of a driver that may engage this recess 1616 or socket 1616 will be discussed in association with FIG. 18.

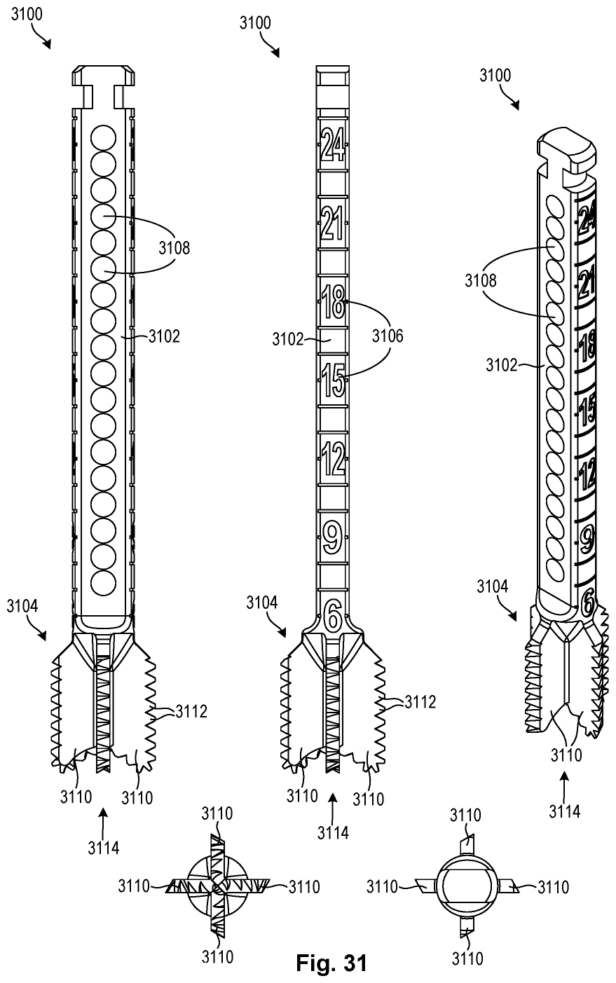

In certain embodiments, the dental implant 1600 may enable a 2-millimeter greater implant diameter to be placed in any given volume of bone. For example, a 5-millimeter dental implant 1600 may be placed where only a 3-millimeter conventional implant would normally fit simply by orienting the flat sides of the dental implant 1600 buccolingually. This not only provides much more surface area for greater primary stability but enables safe crestal-level placement without the danger of thread exposure. The dental implant's wide, self-tapping threads that increase in thickness from apex to its rounded platform 1618 may score the bone during insertion and invite blood supply into the osteotomy, imposing insignificant pressure on the cortical bone, thus protecting the buccal and lingual plates from deterioration. A concave tip 1618 of the dental implant 1600 may provide safety near anatomical structures, a stronger positive stop, and make sinus bumps simpler with matching osteotomes. Diameters as small as 1-millimeter and lengths as short as 3-millimeter make the disclosed dental implant 1600 possible in very narrow and severely resorbed ridges. In certain embodiments, a single-pass bur 3100, as will be discussed in association with FIG. 31, may be used in association with the dental implant 1600 to create an osteotomy in a single pass using aggressive flutes that are designed to quickly cut through angled and dense bone without skiving or overheating.

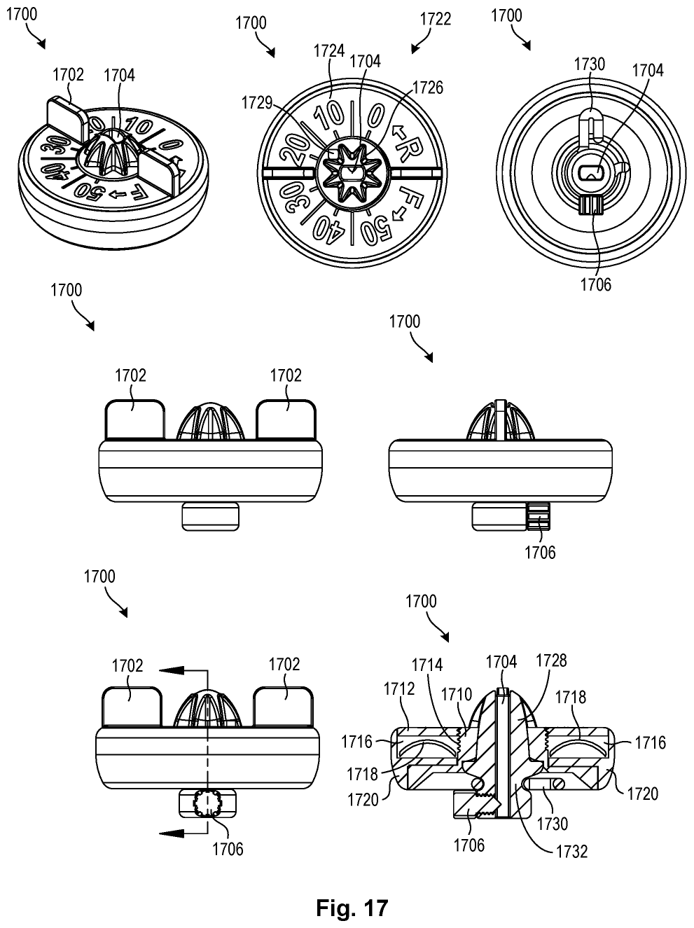

Referring to FIG. 17, in certain embodiments, a finger wheel may be used to facilitate turning and applying torque to various types of drivers or driver tips (such as those illustrated in FIGS. 18 and 19), and thereby apply torque to screw heads. Such a finger wheel may be useful when working in tight spaces, which is typical in dentistry. In certain embodiments, the functionality of such a finger wheel may be expanded to include additional features, such as a ratcheting mechanism to facilitate applying torque in only one direction and a torque feature to ensure that each screw is tightened property and with a desired amount of torque, without overtightening. Various views of one embodiment of such a tool 1700 are illustrated in FIG. 17.

As shown, in certain embodiments, a ratcheting finger wheel 1700 in accordance with the invention includes a handle 1702 and a socket 1704 or internal spline 1704 that is configured to receive a driver shaft, such as the driver shafts illustrated in FIGS. 18 and 19. In certain embodiments, a driver shaft may be configured to exit a top of the ratcheting finger wheel 1700 to enable a user to establish a position (e.g., height) of the ratcheting finger wheel 1700 relative to the driver shaft. In certain embodiments, a set screw 1706 may fix the ratcheting finger wheel 1700 relative to the driver shaft once a desired position is achieved. In certain embodiments, the shape of the socket 1704 or internal spline 1704 is configured to prevent the driver shaft from rotating with respect to the ratcheting finger wheel 1700.

In certain embodiments, the ratcheting finger wheel 1700 includes a base portion 1710 and a rotating portion 1712 that threads 1714 onto the base portion 1710. A cavity 1716 may be formed between the base portion 1710 and the rotating portion 1712. In certain embodiments, a spring washer 1718 or other resilient element 1718 may be utilized within the cavity to create a spring force between the base portion 1710 and the rotating portion 1712. Turning the rotating portion 1712 relative to the base portion 1710 may compress/decompress this spring washer 1718. As shown in FIG. 17, a torque-application portion 1720 may be compressed between the rotating portion 1712 and the base portion 1710 using the spring washer 1718. In certain embodiments, the spring washer 1718 presses up against a wavy or undulating surface on one or more of the rotating portion 1712 and the torque-application portion 1720.

In order to apply torque to a screw, a user may turn the torque-application portion 1720 which may in turn apply torque to the driver shaft. When a specific amount of torque is reached, the torque-application portion 1720 may slip relative to the rotating portion 1712 and base portion 1710 as a result of the spring washer 1718 slipping on the above-described wavy or undulating surface. The amount of torque required for the torque-application portion 1720 to slip may depend on the amount of compressive force that is applied to the spring washer 1718 within the cavity 1716. In certain embodiments, the amount of compressive force may be adjusted.

The ratcheting finger wheel 1700 may be inserted into a patient's mouth to turn screws or other components. Because the ratcheting finger wheel 1700 is a relatively small component, the potential exists for mishandling and/or dropping it in the patient's mouth during use, with the potential that it may even be inadvertently swallowed by the patient. To prevent this from occurring, in certain embodiments, a tether may be coupled to the ratcheting finger wheel 1700. The tether may, in certain embodiments, be coupled to a ring that a dentist may keep on a finger, such as the index finger. In the event the ratcheting finger wheel 1700 falls or is mishandled in the patient's mouth, the ratcheting finger wheel 1700 may be easily retrieved with the tether and ring and thereby avoid swallowing or other issues with the patient. In certain embodiments, the tether is coupled to a removable clip 1730 that grips the ratcheting finger wheel 1700, such as a sleeve 1732 of the ratcheting finger wheel 1700.

FIG. 17 shows one example of a possible top view 1722 of the ratcheting finger wheel 1700. As shown an outer wheel 1724 (which may be the rotating portion 1712) may rotate relative to an inner hub 1726 (which may be the center hub 1728 of the driver 1700). A user may turn the outer wheel 1724 relative to the inner hub 1726 to establish a torque setting for the driver 1700. A gauge 1729 may indicate the torque setting. Similarly, in certain embodiments, turning or clicking the outer wheel 1724 relative to the inner hub 1726 in one of two directions may cause the ratcheting mechanism of the tool 1700 to transition between a forward and reverse setting.

FIG. 18 shows one embodiment of a driver 1800 that may be used to install a dental prosthesis, such as the dental implant 1600 shown in FIG. 16. A front, side, perspective, and end views of the driver 1800 are shown. As shown from the end view 1802, the illustrated embodiment of the driver 1800 includes four teeth 1802 around a circular shank 1803, with two sets of teeth opposite one another, and the teeth of each set offset by thirty degrees. This is just an example and is not intended to be limiting. Other numbers of teeth may also be used. The teeth 1802 may be configured to engage corresponding grooves in the dental implant 1600 that are aligned with the long dimension 1606 of the dental implant 1600. This may ensure that forces are exerted on the dental implant 1600 at locations where the dental implant 1600 is strongest and at locations where the dental implant 1600 has the most material.

As shown, in certain embodiments, the driver 1800 may have a shaft 1804. The shaft 1804 may have a cross-sectional shape that corresponds to a socket 1704 or internal spline 1704 into which the shaft is received. In certain embodiments, the cross-sectional shape of this shaft 1804 is shaped to prevent rotation relative to the socket 1704 or internal spline 1704 into which it is received.

In certain embodiments, the shaft 1804 of the driver 1800 is marked with units 1806 of measurement along a length thereof. This may enable a dentist to select how far the driver 1800 extends from a tool of choice, such as the previously described ratcheting finger wheel 1700. In certain embodiments, the shaft 1804 is equipped with a series of holes 1808 or other features that may be engaged by a tool to accurately establish how far the driver 1800 extends from the tool. For example, the set screw 1706 described in association with FIG. 17 may be used to establish how far the driver 1800 extends from the ratcheting finger wheel 1700.

FIG. 19 shows another embodiment of a driver 1900 that may be used to install a dental prosthesis, such as the ball screw 1200 of FIG. 12, or the tops 1400, 1500 shown in FIGS. 14 and 15. A front, side, perspective, and end views of the driver 1900 are shown. FIG. 20 shows a more closeup view of the side and end of the driver 1900. As shown from the end view 1902, the driver 1900 in this embodiment includes eight teeth 1902 equally spaced around a circular shank 1903. This is just an example and is not intended to be limiting. Other numbers of teeth are possible and within the scope of the invention. The teeth 1902 may be configured to engage corresponding grooves 1212 in a dental prosthesis, such as the ball screw 1200 of FIG. 12, or the tops 1400, 1500 shown in FIGS. 14 and 15.

As evident in FIG. 20, in certain embodiments, an outer contour of the teeth 1902 may follow a generally circular or spherical profile 2002. The grooves 1212 and associated recess 1210 or socket 1210 into which the teeth 1902 fit may be shaped to receive this circular or spherical profile 2002. The end result is that the driver head 1912 or tip 1912 may be configured to rotate within the recess 1210 or socket 1210 much like the ball of a ball joint rotates within its corresponding socket. In certain embodiments, the driver head 1912 may be configured to tilt as much as thirty degrees relative to a normal direction with respect to the recess 1210 or socket 1210 into which the driver head 1912 is placed while still allowing the teeth 1902 to engage the corresponding grooves 1212 and thereby apply torque without slipping. For example, with the tops 1400, 1500 disclosed in FIGS. 14 and 15, the driver 1900 may apply torque to the internal screw 1402 even when it is angled with respect to the internal screw 1402 by as much as thirty degrees.

As was previously mentioned, in certain embodiments, the recess 1210 or socket 1210 of the dental prosthesis may include a rounded pin 1214 or shaft 1214 that may engage a corresponding recess 1910 in the driver 1900. In certain embodiments, the driver 1900 may be designed to allow the driver 1900 to snap onto to this pin 1214 or shaft 1214 to keep the driver head 1912 in place relative to the recess 1210 or socket 1210. This may help to keep the driver centered and engaged with the recess 1210 and prevent any slippage therebetween. The driver head 1912 may be snapped off of this pin 1214 or shaft 1214 after desired torque has been applied. In certain embodiments, the driver head 1912 may be designed with internal projections 2000 or other elements to enable the driver head 1912 to engage the pin 1214 or shaft 1214 and thereby snap into the recess 1210 or socket 1210.

Like the driver 1800 shown in FIG. 18, the driver 1900 may in certain embodiments have a shaft 1904 with a cross-sectional shape that corresponds to a socket 1704 or internal spline 1704 into which the shaft is received. In certain embodiments, the cross-sectional shape of this shaft 1904 is shaped to prevent rotation relative to the socket 1704 or internal spline 1704.

In certain embodiments, the shaft 1904 of the driver 1900 is marked with units 1906 of measurement along a length thereof. This may enable a dentist to select how far the driver 1900 extends from a tool of choice, such as the previously described ratcheting finger wheel 1700. In certain embodiments, the shaft 1904 is equipped with a series of holes 1908 or other features that may be engaged by a tool to accurately establish how far the driver 1900 extends therefrom. For example, the set screw 1706 described in association with FIG. 17 may be used to establish how far the driver 1900 extends from the ratcheting finger wheel 1700.

FIG. 21 shows another embodiment of an upper arch fixator 100 in accordance with the invention. Like the embodiment illustrated in FIG. 1, the upper arch fixator 100 provides a stable mounting site and reference point for a fiducial array as well as a mounting site and reference point for a tracking mechanism of a dental robot. The upper arch fixator 100 may provide a kinematic mount for both the fiducial array and the dental robot in that it may constrain all degrees of freedom of the fiducial array and the dental robot when connected thereto.

As shown, the upper arch fixator 100 includes three posts 108 and an internally threaded aperture 110 to connect the upper arch fixator 100 to external elements such as the fiducial array and dental robot. The three posts 108 may form a stable platform 112 or base 112 and may mate with three corresponding holes in a mounting surface of a fiducial array or dental robot. A screw associated with the mounting surface may be threaded into the internally threaded aperture 110 to pull the mounting surface against the base 112 and thereby rigidly attach the fiducial array or dental robot to the upper arch fixator 100. This may constrain all degrees of freedom of the fiducial array and the dental robot with respect to the upper arch fixator 100.

As shown, the upper arch fixator 100 includes a pair of registration members 102a, 102b that are configured to align with hamular notches of a patient. A centering mechanism 104, in this embodiment a spike 104, is configured to align with and penetrate a centrally located anatomical landmark of the patient, such as the patient's incisive foramen. This will center the upper arch fixator 100 relative to the patient's upper jaw and, when working in concert with the registration members 102a, 102b that reside in the patient's hamular notches, accurately position the upper arch fixator 100 with respect to the patient's upper jaw.

The upper arch fixator 100 may be rigidly attached to the patient's upper jaw using one or more screws or other fasteners installed through one or more apertures 106 of the upper arch fixator 100. The screw or screws, in combination with the centering mechanism 104 and the registration members 102a, 102b, may keep the upper arch fixator 100 firmly mounted within the patient's upper jaw. At least three points of contact (i.e., the two registration members 102a, 102b and the centering mechanism 104) provide a broad and stable platform and connection to the patient's upper jaw, with all degrees of freedom constrained.

As shown in FIG. 21, in certain embodiments, a clip 2100 may be incorporated into the upper arch fixator 100 to retain a breathing tube 900. In certain embodiments, this clip 2100 may partially extend around the breathing tube 900 and allow the breathing tube 900 to be snapped into and out of the clip 2100. The breathing tube 900 may extend into a patient's throat past the patient's tongue (in certain cases just short of the trachea) to keep the patient's airway open while the patient is undergoing treatment. Similarly, as shown in FIG. 21, the registration members 102a, 102b may be hollow to accommodate a tube 800, such as an angled tube 800, to provide suction in the patient's mouth. This may prevent excessive saliva, fluids, and or debris from accumulating in the patient's mouth while the patient is undergoing treatment.

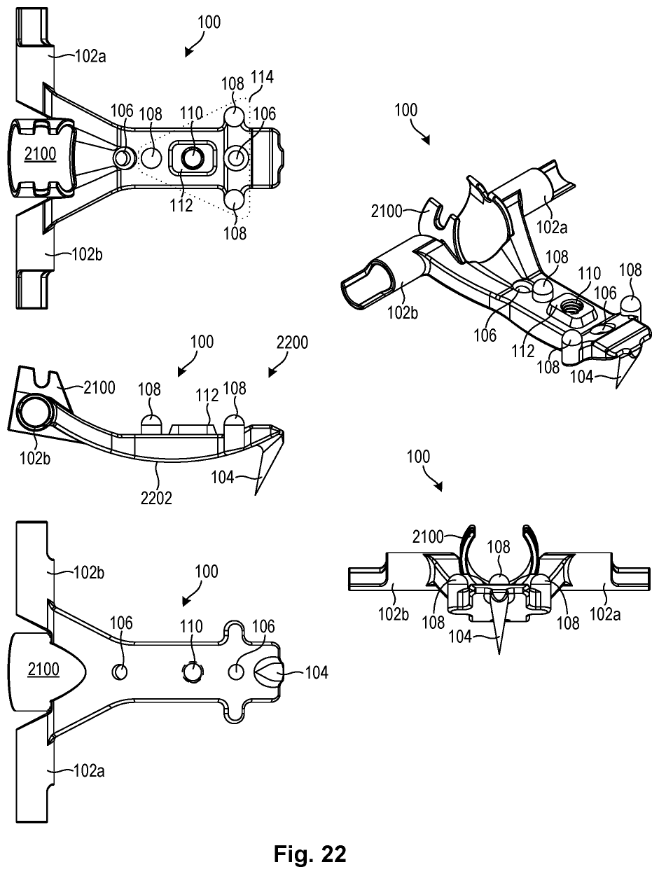

FIG. 22 shows various views of the upper arch fixator 100 of FIG. 21 without the breathing tube 900 installed, including a perspective top, bottom, side, and front view. As shown in the side view 2200, in certain embodiments, the upper arch fixator 100 may have a contour that roughly corresponds to the contour of the patient's palate, thereby allowing the upper arch fixator 100 to conform closely to the patient's upper jaw structure.

Referring to FIG. 23, like the upper arch fixator 100, in certain embodiments a dental appliance 100 (also referred to herein as a “lower arch fixator” 2300) may be used to provide a stable mounting site and reference point with respect to the lower jaw. More specifically, the lower arch fixator 2300 may provide, with respect to the lower jaw, a stable mounting site and reference point for a fiducial array as well as a mounting site and reference point for a tracking mechanism of a dental robot used to perform dental surgery such as implant placement. The lower arch fixator 2300 may in certain embodiments serve as a kinematic mount for both the fiducial array and the dental robot in that it may constrain all degrees of freedom of the fiducial array and the dental robot with respect thereto. FIG. 23 shows various views of one embodiment of a lower arch fixator 2300 in accordance with the invention.

Like the upper arch fixator 100, the lower arch fixator 2300 may also in certain embodiments include three posts 2302 and an internally threaded aperture 2304 to connect the lower arch fixator 2300 to external structures such as the fiducial array and dental robot. An area of the lower arch fixator 2300 defined by the three posts 2302 may form a stable platform 2306 or base 2306. The three posts 2302 may mate with three holes in a mounting surface of the fiducial array and/or dental robot, and a screw associated with the mounting surface may be threaded into the internally threaded aperture 2304. This may pull the mounting surface against the base 2306 to rigidly attach the fiducial array or dental robot to the lower arch fixator 2300. This may constrain all degrees of freedom of the fiducial array and the dental robot with respect to the lower arch fixator 2300. The posts 2302, platform 2306, and internally threaded aperture 2304 may collectively form a lower kinematic mount 2308 for the lower arch fixator 2300.

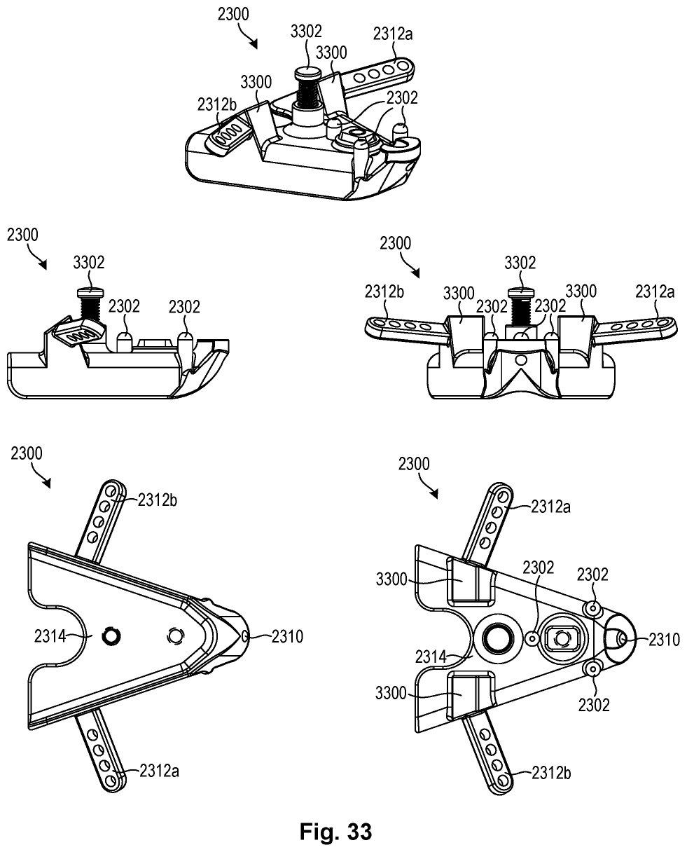

To position and attach the lower arch fixator 2300 to the patient's lower jaw, the lower arch fixator 2300 may in certain embodiments include an aperture 2310 for alignment with a genial tubercle of a patient. A screw may be installed in the jaw bone of the patient just above the genial tubercle. Similarly, screws may be used with the wings 2312a, 2312b to attach the lower arch fixator 2300 to the bone behind the wisdom teeth (e.g., on the retromolar pads). A pin or screw 2316 of the lower arch fixator 2300 may establish a bite of a patient relative to the upper arch fixator 100. This will be discussed in more detail in association with FIG. 33.

As can be observed in FIG. 23, when installed, the lower arch fixator 2300 may include a tray 2314 or fence 2314 to hold a patient's tongue down and keep it out of the way, as well as improve a dentist's visibility into the patient's mouth. This may also prevent the tongue from rolling back in the patient's throat and closing off the patient's airway while the patient is undergoing treatment.

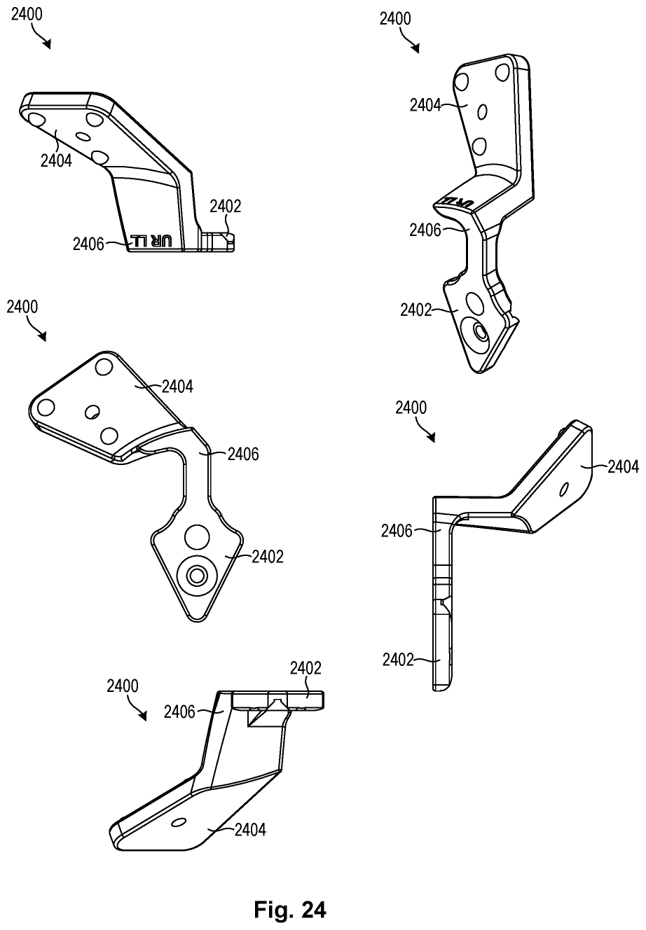

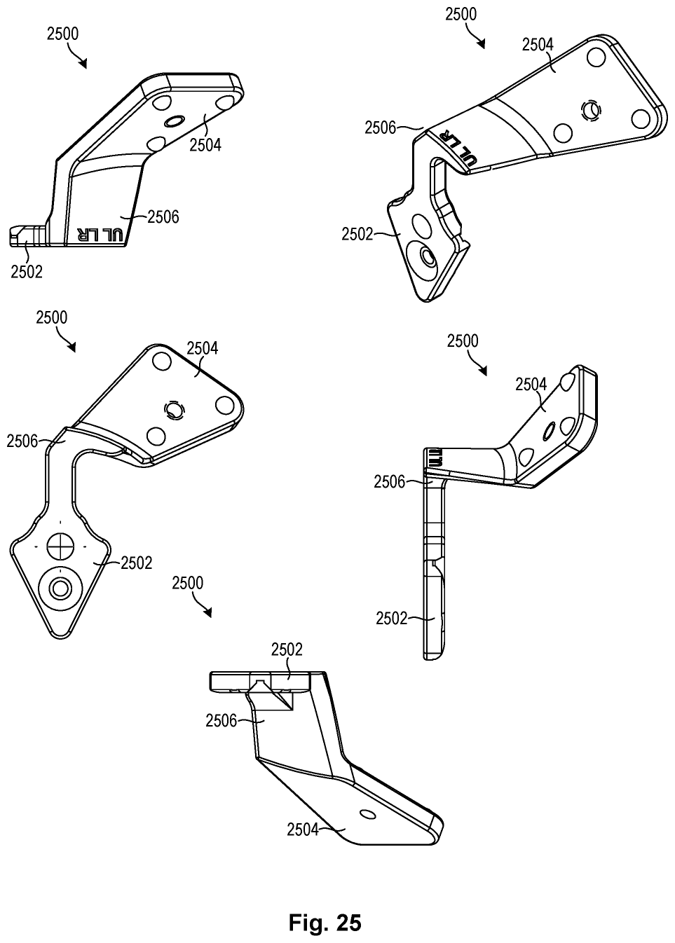

Referring to FIGS. 24 and 25, in certain cases, a fiducial array or robot tracking mechanism may be connected directly to the upper kinematic mount 114 or the lower kinematic mount 2308 of the upper arch fixator 100 or the lower arch fixator 2300 respectively. This will enable the connections to be made within the upper and lower aveolar ridges of the upper and lower jaws respectively. This can be beneficial in certain circumstances. For example, if a fiducial array is designed to reside within the patient's mouth, mostly within the upper and lower aveolar ridges, a conventional cone beam tomography system may be used to image the upper and lower jaws without a need for specialized cone beam tomography systems.

In other cases, the fiducial array and/or robot tracking mechanism may require an attachment outside of the patient's mouth, and more specifically outside of the aveolar ridges of the patient. In such cases, a bracket may be provided that extends from the kinematic mount 114 of the upper arch fixator 100 or the kinematic mount 2308 of the lower arch fixator 2300 to a position outside of the patient's mouth. This may allow the fiducial array and/or robot tracking mechanism to be attached to the bracket outside of the patient's mouth. At the same time, the fiducial array and/or robot tracking mechanism may take advantage of the stability provided by the lower arch fixator 2300 and/or lower arch fixator 2300 respectively. FIGS. 24 and 25 show examples of brackets 2400, 2500 or extensions 2400, 2500 that may be used to extend from the upper kinematic mount 114 and/or lower kinematic mount 2308 to a point outside of the patient's mouth to connect to a fiducial array and/or robot tracking mechanism. In essence, the brackets 2400, 2500 or extensions 2400, 2500 move the attachment point for the upper kinematic mount 114 and/or lower kinematic mount 2308 to a point outside of the patient's mouth.

For example, FIG. 24 shows a bracket 2400 or extension 2400 having a first end 2402 configured to connect to the kinematic mount 114, 2308 of either the upper arch fixator 100 or lower arch fixator 2300, and a second end 2404 configured to replicate the kinematic mount 114, 2308 of the upper arch fixator 100 or lower arch fixator 2300. A neck 2406 may extend between the first end and second end and be configured to extend from inside the patient's mouth to outside the patient's mouth. Similarly, FIG. 25 shows a bracket 2500 or extension 2500 having a first end 2502 configured to connect to the kinematic mount 114, 2308 of either the upper arch fixator 100 or lower arch fixator 2300, and a second end 2504 configured to replicate the kinematic mount 114, 2308 of the upper arch fixator 100 or lower arch fixator 2300. A neck 2506 may extend between the first end and second end and be configured to extend from inside the patient's mouth to outside the patient's mouth. The brackets 2400, 2500 or extensions 2400, 2500 of FIGS. 24 and 25 are basically mirror images of each other, allowing a kinematic mount to be provided on either the left outside of a patient's mouth or the right outside of a patient's mouth depending on which one is used.

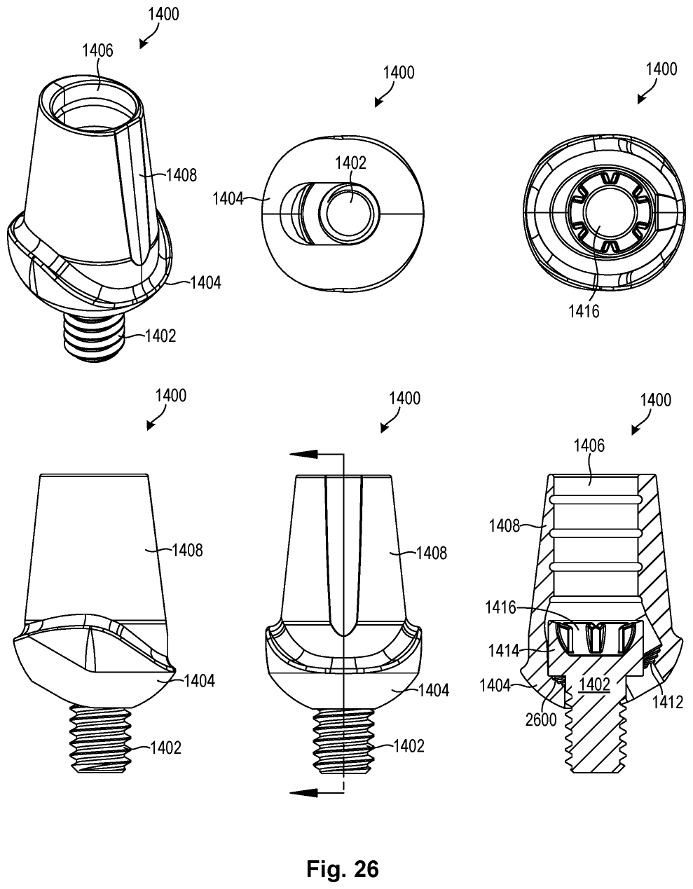

Referring to FIG. 26, in certain embodiments, the “top” 1400 described in association with FIG. 14 may be modified to further resist pivoting or rotation of the cylinder portion 1408 relative to the internal screw 1402 once the angle of the top 1400 is locked into place by tightening the internal screw 1402. For example, in certain embodiments, the rounded internal track 1412 may be modified to include various steps or notches. An underside 2600 of the head 1414 of the internal screw 1402 may be configured to engage these steps or notches when tightened. In certain embodiments, the steps or notches may be established at selected angles (e.g., every five degrees, for example), thereby enabling various discrete angles of the cylinder portion 1408 to be achieved relative to the internal screw 1402. When a desired angle is achieved between the cylinder portion 1408 and the internal screw 1402, the internal screw 1402 may be tightened to lock this angle into place. Loosening the internal screw 1402 may enable the angle to be adjusted. The steps or notches may serve to further prevent pivoting or rotation of the cylinder portion 1408 relative to the internal screw 1402 once the angle is locked into place.

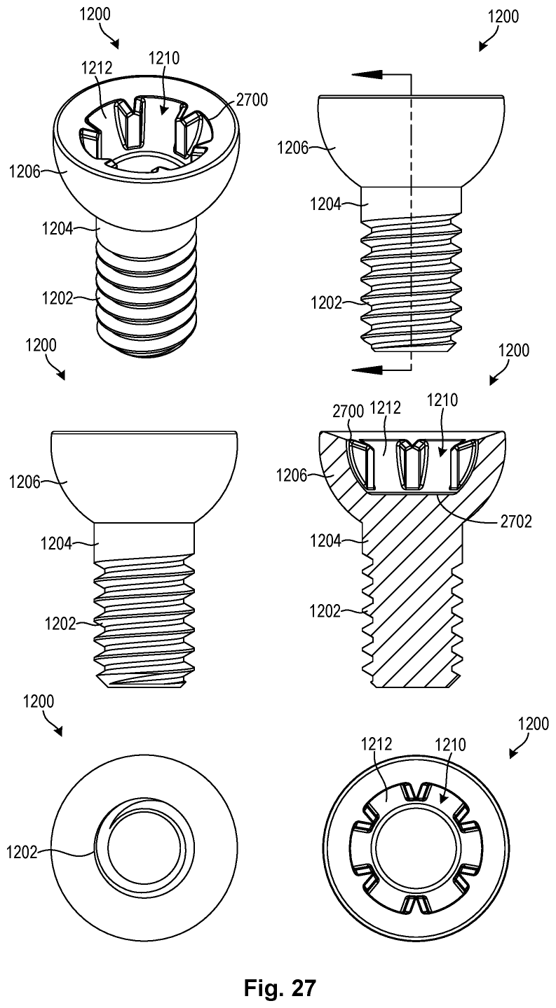

Referring to FIG. 27, various views of another embodiment of a ball screw 1200 in accordance with the invention are illustrated. In this embodiment, the number of grooves 1212 is reduced from eight to six to engage six teeth on a corresponding driver. Furthermore, the rounded pin 1214 is removed. Instead, the driver may be retained in the recess 1210 or socket 1210 by way of a press or interference fit. To achieve this, a diameter of an upper rim 2700 of the recess 1210 or socket 1210 may be designed to be just smaller than an outer diameter of a driver that fits into the recess 1210 or socket 1210. This may allow the driver to snap into and be retained within the recess 1210 or socket 1210. Once the ball screw 1200 is tightened or loosened as desired, the driver may be snapped out of the recess 1210 or socket 1210. Although a bottom 2702 of the recess 1210 or socket 1210 is shown to be flat in the illustrated embodiment, the bottom 2702 may also be rounded to enable the driver to rotate relative to the recess 1210 or socket 1210 and thereby enable rotation of the ball screw 1200 even when the driver is angled relative to the ball screw 1200. In certain embodiments, an angle of up to thirty degrees may be achieved.

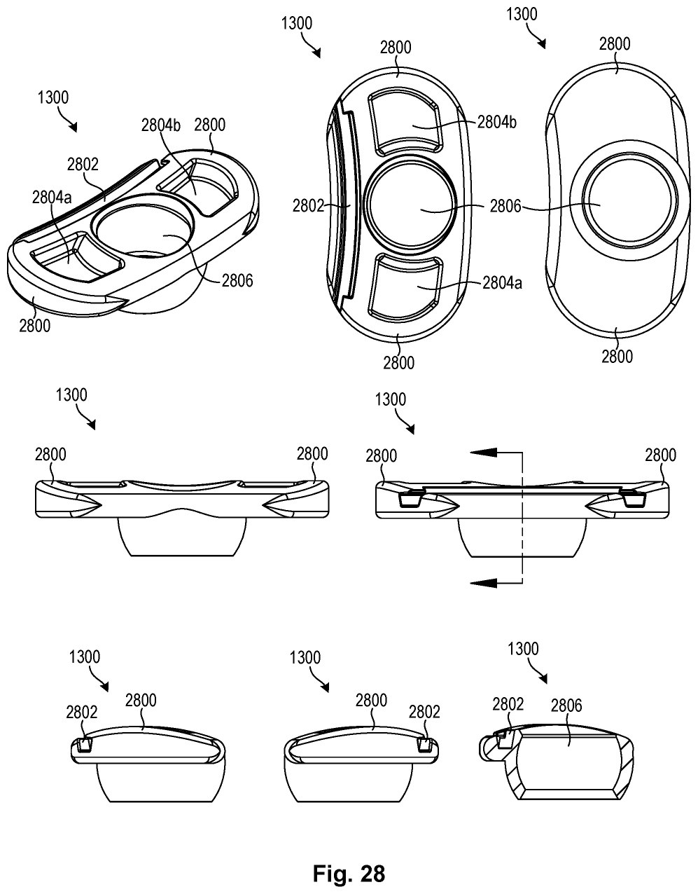

Referring to FIG. 28, various views of another embodiment of a snap cap 1300 in accordance with the invention are illustrated. In this embodiment, the snap cap 1300 is equipped with “wings” that may act as the “skirt” previously described. Stated otherwise, a “skirt” 2800 may be incorporated into the snap cap 1300. As previously mentioned, the skirt 2800 may keep reline material from coming into contact with the ball screw 1200 or other abutment and potentially interfere with the connection between the snap cap 1300 and the abutment. In general, the skirt 2800 may keep the reline material confined to areas where it is needed and prevent it from coming into contact with items or objects where it is not needed or wanted. The skirt 2800 may keep undercuts, blood, saliva, sutures etc. in the patient's mouth from coming into contact with the reline material. In addition, the skirt 2800 may groom and shape the patient's tissue bed during healing.

Once the snap caps 1300 are installed on ball screws 1200 that have been installed in implants in the patient's mouth, an orthodontic wire may be placed in slots 2802 or grooves 2802 incorporated into the snap caps 1300. This may parallelize and/or align the snap caps 1300 in preparation to embed the snap caps 1300 in reline material. As previously explained, the reline material may be used to incorporate the snap caps 1300 into a full-arch shell temporary 700 or other dental prosthesis. In certain embodiments, wells 2804a, 2804b may be incorporated into the snap cap 1300. When reline material is placed around the snap caps 1300, the reline material may enter these wells to assist in bonding the snap caps 1300 to the full-arch shell temporary 700 or other dental prosthesis.

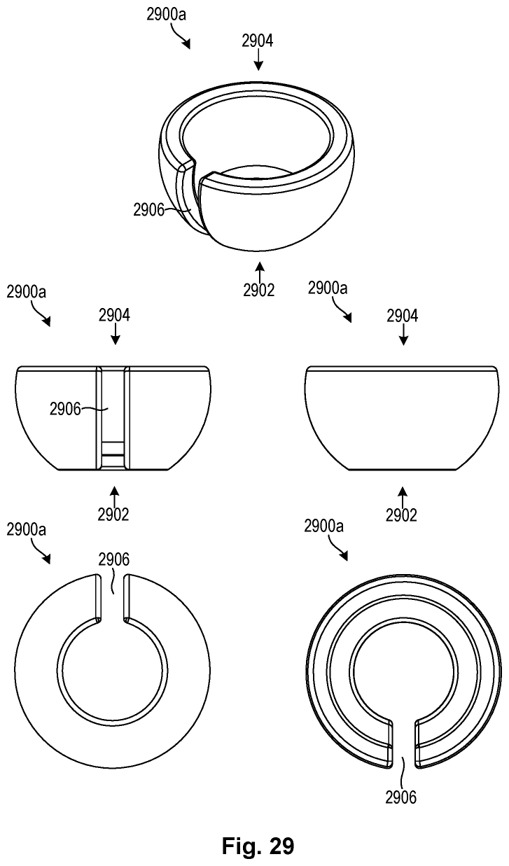

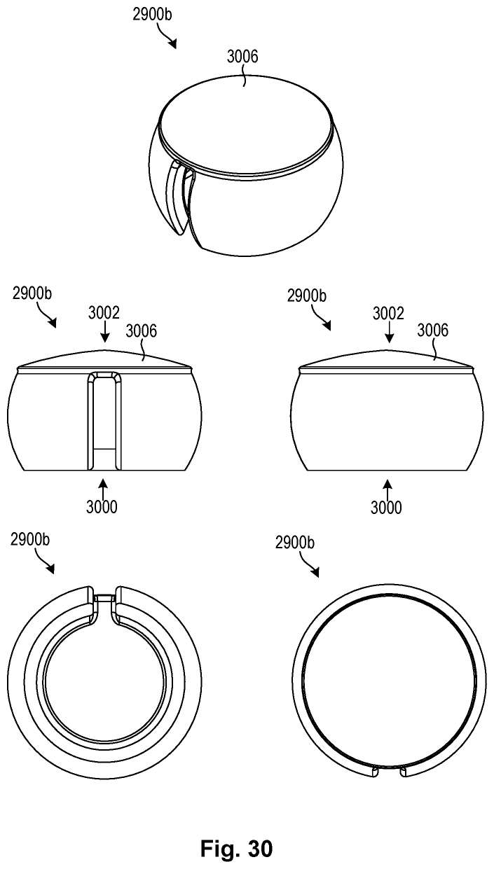

In certain embodiments, various types of inserts 2900 may be used with the snap cap 1300 to make the snap cap 1300 fixed or removal. These inserts 2900 may fit into a socket 2806 incorporated into the snap cap 1300. FIGS. 29 and 30 show several examples of inserts 2900 that may be used with the snap cap 1300. For example, FIG. 29, shows one embodiment of an insert 2900a that is open on both ends. The open bottom 2902 is configured to engage the bottom or underside of the ball of a ball screw 1200 such that the insert 2900a will not disengage from the ball screw 1200 without removing the ball screw 1200. The top 2904 is open to enable placement and access to the ball screw 1200 through the top of the insert 2900a. In certain embodiments, the insert 2900a includes a slot 2906 to enable the insert 2900a to compress and thereby be inserted into the socket 2806, or compress for removal from the socket 2806. Thus, the insert 2900a may in certain embodiments be made of a flexible material such as plastic to enable it to bend or compress. Once the ball screw 1200 is placed in the insert 2900, the insert 2900a may no longer compress and the insert 2900a may be retained within the socket 2806. The ball screw 1200 may be screwed into an abutment such as the crucible previously discussed to keep the snap cap 1300 and associated insert 2900a retained with respect thereto. The snap cap 1300 and associated insert 2900a may be removed by removing the ball screw 1200.

In another embodiment, as shown in FIG. 30, an insert 2900b may be configured to be removable from a ball screw 1200 without actually removing the ball screw 1200. That is, the insert 2900b may snap on an off of a ball screw 1200 without requiring any manipulation of the ball screw 1200. In such an embodiment, a bottom 3000 of the insert 2900b may be sized to engage an underside of the ball screw 1200 for retention purposes, but may be sized and have sufficient flexibility to enable it to snap on and off the ball screw 1200 without having to manipulate (e.g., tighten, loosen, etc.) the ball screw 1200. Such an embodiment may be useful for a full-arch shell temporary 700 or other dental prosthesis that snaps into or out of a patient's mouth without having to place or remove screws or other fasteners to do so. In certain embodiments, a top 3002 of the insert 2900b may be equipped with a cover 3006 to prevent reline material or other matter from entering the insert 2900b. Like the previously described insert 2900a, the insert 2900a may include a slot 2906 to enable the insert 2900a to compress for insertion into the socket 2806, or compress for removal from the socket 2806.

Referring to FIG. 31, when placing implants, holes need to be initially drilled in the patient's jaw to accommodate the implants. Conventionally, this may require drilling a pilot hole and stepping up in bur sizes to create a hole of a desired diameter. This may require several passes which may add time to a dental procedure and require multiple different tools. It would be an advance in the art to provide a bur that can produce holes of a desired shape and diameter in a single pass without the need for a pilot hole or stepping up in bur sizes. FIG. 31 shows one example of a single-pass bur that may achieve such a result.

In certain embodiments, a single-pass bur 3100 in accordance with the invention may include a shaft 3102 and a drill head 3104. The shaft 3102 of the single-pass bur 3100 may be marked with units 3106 of measurement along a length thereof. This may enable a dentist to establish how far the single-pass bur 3100 extends from a tool of choice, such as a robotically guided drill. In certain embodiments, the shaft 3102 is equipped with a series of holes 3108 or other features that may be engaged by a tool to accurately establish how far the single-pass bur 3100 extends therefrom.

The drill head 3104 may be characterized by multiple flutes 3110 (e.g., four flutes 3110), each with multiple cutting teeth 3112. In certain embodiments, the cutting teeth 3112 are offset from one another such that when the drill head 3104 rotates to create a hole, the cutting teeth 3112 on each of the flutes 3110 collectively form a substantially smooth round hole. Furthermore, an end contour 3114 of the drill head 3104 may create a concave shape in the bone such that edges of the hole will be deeper than a center of the hole. This may conform to the shape of an implant (such as the implant described in association with FIG. 16) and ensure that the implants stop when they reach a bottom of the hole. It may also facilitate use of a matching osteotome in the event a dentist desires to create a sinus bump or lift at the end of the drilled hole. Ideally, because the single-pass bur 3100 does not include a pilot or centering mechanism, the single-pass bur 3100 is used with a precision and guided drilling device, such as a robotically assisted drill, to ensure that the single-pass bur 3100 drills in a desired location and does not deviate from a desired path.

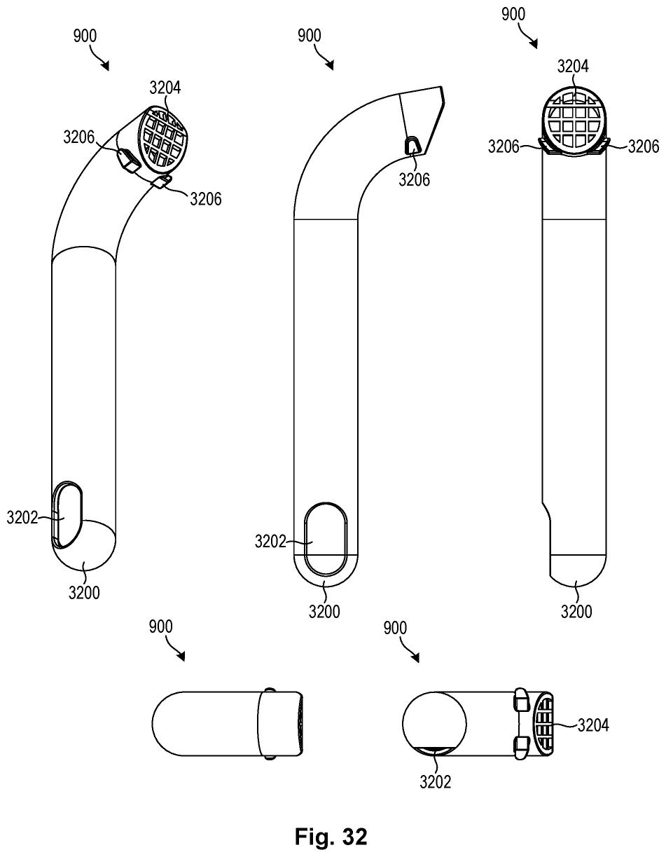

Referring to FIG. 32, another embodiment of a breathing tube 900 in accordance with the invention is illustrated. Such a breathing tube 900 may be used with the arch fixator 100 previously described when a patient is not nasally intubated. The breathing tube 900 may keep a patient's airway open while undergoing treatment. As shown, the breathing tube 900 may in certain embodiments include a rounded end 3200 that extends into a patient's throat. This rounded end 3200 may be void of sharp edges that could damage or irritate a patient's throat when it is placed therein. The rounded end 3200 may include an aperture 3202 on a side thereof to make obstruction less likely than if it were placed on a front or back of the breathing tube 900. In certain embodiments, the other end of the breathing tube 900 may include a screen 3204 to prevent objects or debris from entering the breathing tube 900 while also allowing air to pass therethrough. A pair of tabs 3206 may be provided on the breathing tube 900 to engage a clip on the upper arch fixator 100, such as the clip 2100 shown in FIG. 21. This may help to keep the breathing tube 900 from falling off the upper arch fixator 100 and potentially becoming lodged in the patient's throat.

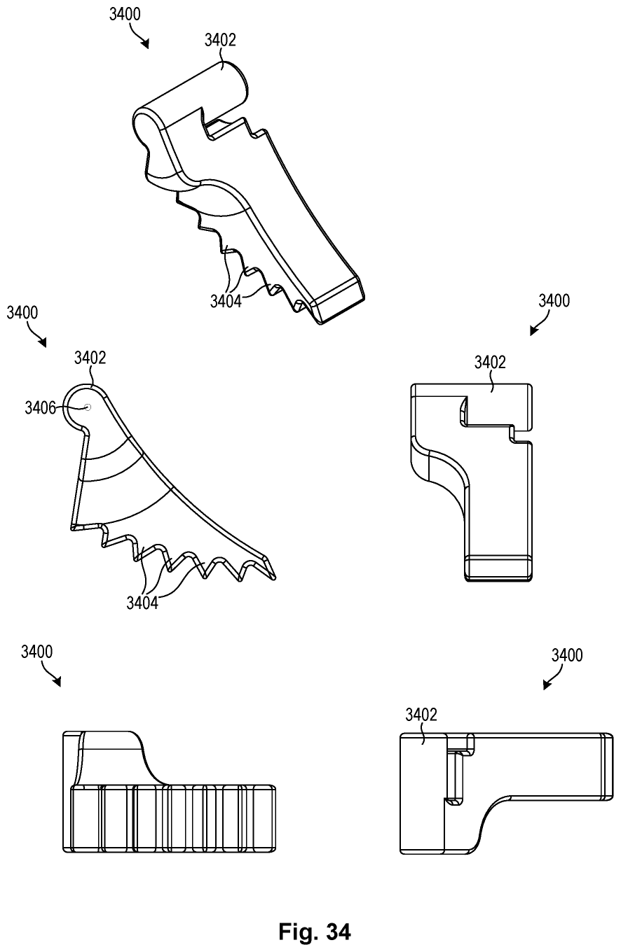

Referring to FIG. 33, while also referring to FIG. 34, in certain embodiments in accordance with the invention, the lower arch fixator 2300 may be modified to work with a bite block 3400 as shown in FIG. 34. The bite block 3400 may be used to stabilize a patient's jaw and maintain a consistent and comfortable opening during various dental procedures. The bite block 3400 may be used to maintain a stable and open bite during a procedure from well behind the surgical area. This may facilitate access to the area of the jaw or mouth that is undergoing treatment as well as prevent patient jaw fatigue during longer dental procedures.

As shown in FIGS. 33 and 34, in certain embodiments the lower arch fixator 2300 is equipped with shoulders 3300 that are configured to engage teeth of the bite block 3400. The bite block 3400, by contrast, may be configured to pivot with respect to the upper arch fixator 100, such as on a cylindrical registration member 102 of the upper arch fixator 100. More specifically, in certain embodiments, a cylinder 3402 or pin 3402 of the bite block 3400 may be configured to slide into a registration member 102 of the upper arch fixator 100 and pivot with respect thereto. One of the teeth 3404 of the bite block 3400 may be pivoted to engage a shoulder 3300 of the lower arch fixator 2300 to fix the patient's bite and prevent closing of the patient's jaw. Each tooth 3404 on the bite block 3400 may reside at a different distance from a pivot point 3406 and thus each tooth 3404 may hold the patient's jaw open by a different amount when engaged with the shoulder 3300 of the lower arch fixator 2300.

In addition, in certain embodiments, the lower arch fixator 2300 may be equipped with a screw 3302 that threads into an internally threaded aperture. This screw 3302 may be used to register or record a bite of the patient. Specifically, a head of the screw 3302 may contact a surface of the upper arch fixator 100 to register and record the bite. For example, if the patient's upper and lower teeth contact each other at a certain angle, the screw 3302 may be adjusted to register the angle at which the patient's teeth make contact or are in occlusion with one another. That is, the screw 3302 may be adjusted to make contact with the upper arch fixator 100 at the same time the patient's upper and lower teeth contact or are in occlusion with one another. Recording this angle may be important if the patients' teeth are extracted and the dentist wishes to recreate the patient's bite at the same angle with a new set of prosthetic teeth. Alternatively, if a patient has no teeth to begin with, the screw 3302 may be used by a dentist to establish an anatomically correct angle or vertical dimension of occlusion (VDO) at which to install a new set of prosthetic teeth. The vertical dimension of occlusion may be determined, for example, by measuring 24-milimeters between the upper and lower muco-gingival junctions of the patient. Once the proper screw 3302 height is set, the bite may be replicated every time the patient's jaw is closed, and a CBCT scan or other imaging may be taken in this position.

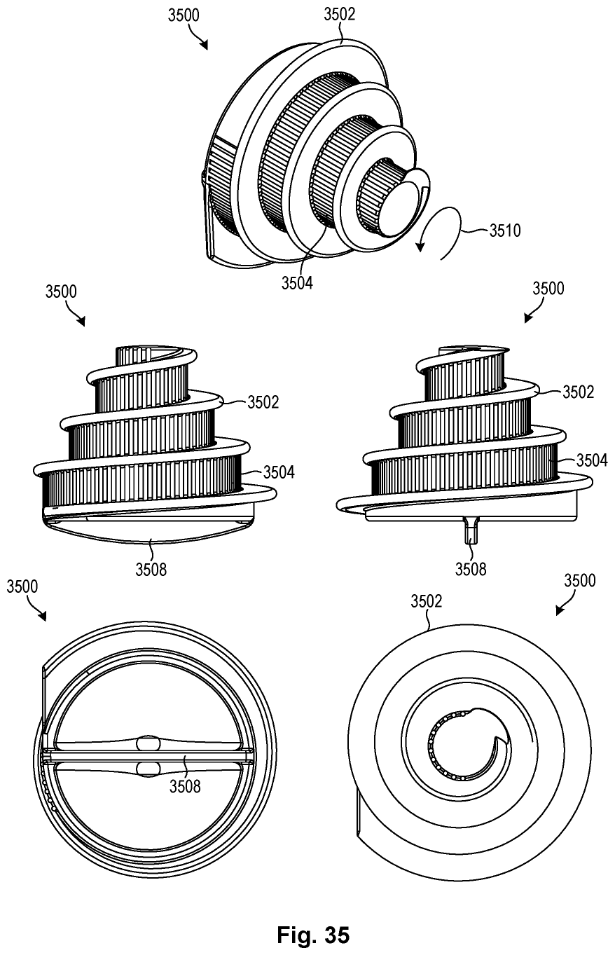

Referring to FIG. 35, in another embodiment, a bite block 3500 may in certain embodiments be implemented as a helical structure. This helical structure may, in certain embodiments, be made up of a retention rim 3502 and a biting surface 3504. A patient's teeth may be placed on the bite block 3500 such that the patient's upper and lower teeth are incident on opposite sides of the biting surface 3504. If the patient is toothless, the alveolar ridges of the patient's jaw may be placed on the bite block 3500. The retention rim 3502 make keep the patient's teeth on the biting surface 3504. In order to widen the angle of the patient's jaw and increase the patient's bite, the bite block 3500 may be turned in a direction 3510 to urge the patient's teeth onto a wider diameter section of the biting surface 3504. A handle 3504 may be provided to enable this rotation by hand. Similarly, the angle of the patient's jaw and the patient's bite may be reduced by turning it in the opposite direction. In certain embodiments, the biting surface 3504 is textured to enable the patient's teeth to grip the bite block 3500. The bite block 3500 may in certain embodiments be fabricated from rubber or another pliable material to provide a comfortable experience for the patient when biting down on the bite block 3500.

In implant dentistry, implant surgery is often prosthetically driven, which means that knowing final teeth locations is important for proper case planning. The prosthesis may be planned first, followed by implant sites, and finally, engineer the connection via the proper abutment. The systems and methods disclosed herein simplify case planning and enable a surgeon to perform steps in their proper order, both preoperatively as well as surgically. Once a bite has been captured using an X-ray, digitized full-arch shell temporaries 700 in full occlusion may be uploaded and aligned by selecting reference points associated with the kinematic mount 114, 2308 of the arch fixator 100, 2300. When not using an arch fixator 100, 2300, the full-arch shell temporaries 700 may be aligned with the incisive foramen and the hamular notches. Case planning may now be completed, since the digital full-arch shell temporaries 700 are in their proper physiological position, establishing the midline, occlusal plane, and every tooth's final position. During surgery, a shell guide may be mounted to the arch fixators 100, 2300 to visualize tooth positions, confirm proper implant placement and optimal screw channel emergence in the final. The border of the full-arch shell temporary 700 may form a bone reduction plane both digitally as well as intra-operatively, thereby guaranteeing sufficient restorative space. However, since the abutments disclosed herein require no added restorative space, bone reduction is unnecessary except to hide any transition line in patients with a gummy smile.

The full-arch shell temporary 700 conversion takes a short amount of time and can be performed by a dental assistant. This may be accomplished by inserting a ball screw 1200 on each global abutment (e.g., the abutment base 1000) following by a snap cap 1300 (e.g., the snap cap 1300 illustrated in FIG. 28). An orthodontic wire may then be inserted into the slots 2082 of the snap caps 1300 to parallel the snap caps 1300 and to create an ideal path. The wings 2800 of the snap caps 1300 prevent reline material from mixing with blood or trapping sutures and groom an ideal tissue bed during healing. The upper arch 400 of the full-arch shell temporary 700 may be mounted to the upper arch fixator 100 and filled up with a fast-set resin until it gels. A liner on the upper arch 400 of the full-arch shell temporary 700 may then be stripped. Reline material may then be injected into retention grooves (e.g., wells 2804a, 2804b) of the snap caps 1300 and the upper arch 400 of the full-arch shell temporary 700 may then be reinserted to capture the snap caps 1300. The full-arch shell temporary 700 may then be trimmed and polished, thereby providing a set of removable temporaries on arches which are ready for fixed finals. With no messy screw channels, the full-arch shell temporaries 700 are easy to service and extremely strong, making broken temporaries a rare occurrence. Scanning for finals may now be quicker and easier since the ball screws 1200 may also act as scan bodies. This may be accomplished by removing the full-arch shell temporary 700 from the patient's mouth, scanning the patient's arches, and reinserting the full-arch shell temporary 700. When a fixed full-arch shell temporary 700 is preferred, a dentist may use the open-ended inserts (e.g., as shown in FIG. 29) and retro-drill screw channels before re-inserting. When creating a final in the laboratory, each screw channel may be moved up to 30 degrees in any direction for ideal emergence in the cingulum or occlusal surface. The snap caps 1300 also make fabricating a removable final possible, whether as a chairside pickup or a laboratory-made overdenture and may easily convert a removable prosthesis into a fixed prosthesis in a short amount of time. The replaceable inserts 2900 may come in various retention strengths and may be labeled for easy identification.

While various embodiments of the present disclosure have been described above, it should be understood that they have been presented by way of example only and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments, but should be defined only in accordance with the following claims and their equivalents. The foregoing description has been presented for the purposes of illustration and description. It is not intended to be exhaustive or to limit the disclosure to the precise form disclosed. Many modifications and variations are possible in light of the above teachings. Further, it should be noted that any or all of the aforementioned alternate implementations may be used in any combination desired to form additional hybrid implementations of the disclosure.

1. An apparatus for providing a stable reference and mounting point within a patient's jaw, the apparatus comprising:
a dental appliance for affixing within a jaw of a patient, wherein the dental appliance is sized and shaped to substantially reside within an arch created by an alveolar ridge of the jaw, the dental appliance providing a mounting site for a tracking mechanism of a surgical robot.

2. The apparatus of claim 1, wherein the dental appliance further provides a mounting site for fiducial markers used to image the jaw.

3. The apparatus of claim 1, wherein the dental appliance further provides a temporary mounting site for an arch of prosthetic teeth.

4. The apparatus of claim 3, wherein the arch of prosthetic teeth is a full arch of prosthetic teeth.

5. The apparatus of claim 1, wherein affixing comprises rigidly affixing with respect to the jaw.

6. The apparatus of claim 1, wherein the jaw comprises one of a maxilla and a mandible of the jaw.

7. The apparatus of claim 1, wherein the dental appliance comprises registration members that are designed to reside in hamular notches of the jaw.

8. The apparatus of claim 1, wherein the dental appliance is configured to make at least three points of contact with the jaw.

9. The apparatus of claim 1, wherein the dental appliance is further configured to hold down a tongue of the patient.

10. The apparatus of claim 1, wherein affixing comprising affixing with at least one screw.

11. A method for providing a stable reference and mounting point within a patient's jaw, the method comprising:
affixing a dental appliance within a jaw of a patient, the dental appliance comprising a size and shape to substantially reside within an arch created by an alveolar ridge of the jaw, the dental appliance providing a mounting site for a tracking mechanism of a surgical robot.

12. The method of claim 11, further comprising connecting, to the mounting site, fiducial markers used to image the jaw.

13. The method of claim 11, further comprising temporarily connecting, to the mounting site, an arch of prosthetic teeth.

14. The method of claim 13, wherein the arch of prosthetic teeth is a full arch of prosthetic teeth.

15. The method of claim 11, wherein affixing comprises rigidly affixing with respect to the jaw.

16. The method of claim 11, wherein affixing comprising affixing with at least one screw.

17. The method of claim 11, wherein affixing within the jaw comprises affixing within one of a maxilla and a mandible of the jaw.

18. The method of claim 11, wherein affixing within the jaw comprises placing registration members of the dental appliance in hamular notches of the jaw.

19. The method of claim 11, wherein affixing within the jaw comprises creating at least three points of contact between the dental appliance and the jaw.

20. The method of claim 11, further comprising using the dental appliance to hold down a tongue of the patient.
